(19) United States
(12) Patent Application Publication
(10) Pub. No.: US 2024/0365450 A1
(43) Pub. Date: Oct. 31, 2024

(54) LOAD CONTROL DEVICE FOR A LIGHT-EMITTING DIODE LIGHT SOURCE

(71) Applicant: Lutron Technology Company LLC, Coopersburg, PA (US)

(72) Inventors: Venkatesh Chitta, Center Valley, PA (US); Jeffrey S. Hayes, Allentown, PA (US); Robert D. Stevens, Jr., Emmaus, PA (US)

(73) Assignee: Lutron Technology Company LLC, Coopersburg, PA (US)

(21) Appl. No.: 18/768,471

(22) Filed: Jul. 10, 2024

Related U.S. Application Data
(63) Continuation of application No. 18/329,859, filed on Jun. 6, 2023, now Pat. No. 12,069,784.
Application No. 18/329,859 is a continuation of application No. 17/728,609, filed on Apr. 25, 2022, now Pat. No. 11,711,875.
Application No. 17/728,609 is a continuation of application No. 17/216,378, filed on Mar. 29, 2021, now Pat. No. 11,317,491.
Application No. 17/216,378 is a continuation of application No. 16/870,646, filed on May 8, 2020, now Pat. No. 10,966,299.
Application No. 16/870,646 is a continuation of application No. 16/510,028, filed on Jul. 12, 2019, now Pat. No. 10,652,980.
Application No. 16/510,028 is a continuation of application No. 16/179,774, filed on Nov. 2, 2018, now Pat. No. 10,375,781.
Application No. 16/179,774 is a continuation of application No. 15/864,662, filed on Jan. 8, 2018, now Pat. No. 10,136,484.
Application No. 15/864,662 is a continuation of application No. 15/355,230, filed on Nov. 18, 2016, now Pat. No. 9,888,535.
Application No. 15/355,230 is a continuation of application No. 14/974,853, filed on Dec. 18, 2015, now Pat. No. 9,538,600.
Application No. 14/974,853 is a continuation of application No. 14/536,491, filed on Nov. 7, 2014, now Pat. No. 9,247,608.
(60) Provisional application No. 62/032,229, filed on Aug. 1, 2014.
(60) Provisional application No. 61/901,480, filed on Nov. 8, 2013.

(51) Int. Cl. H05B 45/38; H02M 1/00; H02M 1/08; H02M 3/00; H02M 3/335; H05B 44/00; H05B 45/10; H05B 45/327; H05B 45/345; H05B 45/37; H05B 45/3725; H05B 45/375; H05B 45/385; H05B 45/39; H05B 45/395; H05B 45/50

(52) U.S. Cl. CPC H05B 45/38; H02M 1/08; H02M 3/33507; H02M 3/33569; H02M 3/33571; H05B 44/00; H05B 45/10; H05B 45/327; H05B 45/345; H05B 45/37; H05B 45/385; H05B 45/39; H05B 45/395; H05B 45/50; H02M 1/0009; H02M 1/0035; H02M 1/0058; H02M 3/01; H05B 45/3725; H05B 45/375; Y02B 70/10

(57) ABSTRACT

A method for controlling an amount of power delivered to an electrical load may include controlling an average magnitude of a load current towards a target load current that ranges from a maximum-rated current to a minimum-rated current in a normal mode and controlling the average magnitude of the load current below the minimum-rated current in a burst mode. The burst mode may include at least one burst-mode period that comprises a first time period associated with an active state and a second time period associated with an inactive state. During the burst mode, the method may include regulating a peak magnitude of the load current towards the minimum-rated current during the active state and stopping the generation of at least one drive signal during the inactive state to control the average magnitude of the load current to be less than the minimum-rated current.

### CROSS-REFERENCE TO RELATED APPLICATIONS

This application is a continuation of U.S. Non-Provisional application Ser. No. 18/329,859, filed Jun. 6, 2023; which is a continuation of U.S. Non-Provisional application Ser. No. 17/728,609, filed Apr. 25, 2022, now U.S. Pat. No. 11,711,875, issued Jul. 25, 2023; which is a continuation of U.S. Non-Provisional application Ser. No. 17/216,378, filed on Mar. 29, 2021, now U.S. Pat. No. 11,317,491, issued Apr. 26, 2022; which is a continuation of U.S. Non-Provisional application Ser. No. 16/870,646, filed May 8, 2020, now U.S. Pat. No. 10,966,299, issued Mar. 30, 2021; which is a continuation of U.S. Non-Provisional application Ser. No. 16/510,028, filed Jul. 12, 2019, now U.S. Pat. No. 10,652,980 issued May 12, 2020; which is a continuation of U.S. Non-Provisional application Ser. No. 16/179,774, filed Nov. 2, 2018, now U.S. Pat. No. 10,375,781 issued Aug. 6, 2019; which is continuation of U.S. Non-Provisional application Ser. No. 15/864,662, filed Jan. 8, 2018, now U.S. Pat. No. 10,136,484 issued Nov. 20, 2018; which is a continuation of U.S. Non-Provisional application Ser. No. 15/355,230, filed Nov. 18, 2016, now U.S. Pat. No. 9,888,535 issued Feb. 6, 2018; which is a continuation of U.S. Non-Provisional application Ser. No. 14/974,853, filed Dec. 18, 2015, now U.S. Pat. No. 9,538,600 issued Jan. 3, 2017; which is a continuation of U.S. Non-Provisional application Ser. No. 14/536,491, filed on Nov. 7, 2014, now U.S. Pat. No. 9,247,608 issued Jan. 26, 2016, all of which claim the benefit of U.S. Provisional Application No. 62/032,229 filed on Aug. 1, 2014, and U.S. Provisional Application No. 61/901,480 filed on Nov. 8, 2013, and all of which are incorporated by referenced herein in their entireties.

### BACKGROUND

Light-emitting diode (LED) light sources (i.e., LED light engines) are often used in place of or as replacements for conventional incandescent, fluorescent, or halogen lamps, and the like. LED light sources may comprise a plurality of light-emitting diodes mounted on a single structure and provided in a suitable housing. LED light sources are typically more efficient and provide longer operational lives as compared to incandescent, fluorescent, and halogen lamps. In order to illuminate properly, an LED driver control device (i.e., an LED driver) must be coupled between an alternating-current (AC) source and the LED light source for regulating the power supplied to the LED light source. The LED driver may regulate either the voltage provided to the LED light source to a particular value, the current supplied to the LED light source to a specific peak current value, or may regulate both the current and voltage.

LED light sources are typically rated to be driven via one of two different control techniques: a current load control technique or a voltage load control technique. An LED light source that is rated for the current load control technique is also characterized by a rated current (e.g., approximately 350 milliamps) to which the peak magnitude of the current through the LED light source should be regulated to ensure that the LED light source is illuminated to the appropriate intensity and color. In contrast, an LED light source that is rated for the voltage load control technique is characterized by a rated voltage (e.g., approximately 15 volts) to which the voltage across the LED light source should be regulated to ensure proper operation of the LED light source. Typically, each string of LEDs in an LED light source rated for the voltage load control technique includes a current balance regulation element to ensure that each of the parallel legs has the same impedance so that the same current is drawn in each parallel string.

It is known that the light output of an LED light source can be dimmed. Different methods of dimming LEDs include a pulse-width modulation (PWM) technique and a constant current reduction (CCR) technique. Pulse-width modulation dimming can be used for LED light sources that are controlled in either a current or voltage load control mode/technique. In pulse-width modulation dimming, a pulsed signal with a varying duty cycle is supplied to the LED light source. If an LED light source is being controlled using the current load control technique, the peak current supplied to the LED light source is kept constant during an on time of the duty cycle of the pulsed signal. However, as the duty cycle of the pulsed signal varies, the average current supplied to the LED light source also varies, thereby varying the intensity of the light output of the LED light source. If the LED light source is being controlled using the voltage load control technique, the voltage supplied to the LED light source is kept constant during the on time of the duty cycle of the pulsed signal to achieve the desired target voltage level, and the duty cycle of the load voltage is varied in order to adjust the intensity of the light output. Constant current reduction dimming is typically only used when an LED light source is being controlled using the current load control technique. In constant current reduction dimming, current is continuously provided to the LED light source, however, the DC magnitude of the current provided to the LED light source is varied to thus adjust the intensity of the light output. Examples of LED drivers are described in greater detail in commonly-assigned U.S. Pat. No. 8,492,987, issued Jul. 23, 2010, and U.S. Patent Application Publication No. 2013/0063047, published Mar. 14, 2013, both entitled LOAD CONTROL DEVICE FOR A LIGHT-EMITTING DIODE LIGHT SOURCE, the entire disclosures of which are hereby incorporated by reference.

### SUMMARY

As described herein, a method may be used to control the amount of power delivered to an electrical load in a normal mode and in a burst mode. The method may include controlling a magnitude of a load current conducted through the electrical load to control the amount of power delivered to the electrical load, for example, by controlling an average magnitude of the load current conducted through the electrical load. In the normal mode, the method may include regulating the average magnitude of the load current towards a target load current. The target load current may range from a maximum rated current to a minimum rated current. In the burst mode, the method may include controlling the load current in an active state and in an inactive state to regulate the average magnitude of the load current below the minimum rated current. The burst mode may comprise periods of the active state and periods of the inactive state. For example, the method may include regulating a peak magnitude of the load current towards the minimum rated current during the first period using a feedback signal generated by a control loop. Regulation of the load current may stop during a second period such that the average magnitude of the load current is below the minimum rated current.

A method may be used to control the amount of power delivered to an electrical load in a normal mode and in a burst mode. The method may include controlling a magnitude of a load current conducted through the electrical load to control the amount of power delivered to the electrical load. The method may include controlling an average magnitude of the load current conducted through the electrical load. In the burst mode, the method may include controlling the load current in an active state and in an inactive state to regulate the average magnitude of the load current below the minimum rated current. The burst mode may comprise periods of the active state and periods of the inactive state. The duration of the active state of the burst mode period may be determined based on a burst duty cycle. In the normal mode, the method may include holding the burst duty cycle and adjusting the target load current according to a target amount of power to be delivered to the electrical load. In the burst mode, the method may include adjusting the burst duty cycle and/or the target load current. For example, in the burst mode, the method may include determining a current offset that ranges from a minimum current offset to a maximum current offset based on the burst duty cycle and the target amount of power to be delivered to the electrical load and adjusting the target load current by the current offset.

A method may be used to control the amount of power delivered to an electrical load in a normal mode and in a burst mode. The method may include controlling an average magnitude of the load current conducted through the electrical load. In the normal mode, the method may include regulating the average magnitude of the load current between a maximum rated current and a minimum rated current. In the burst mode, the method may include regulating a peak magnitude of the load current towards a target load current during a first period of the burst mode and stopping regulating the load current during a second period of the burst mode such that the average magnitude of the load current is below the minimum rated current. The method may include increasing the magnitude of the load current from an initial current to the target load current over a ramp time period at a beginning of the first period of the burst mode.

### BRIEF DESCRIPTION OF THE DRAWINGS

FIG. 1 is a simplified block diagram of a light-emitting diode (LED) driver for controlling the intensity of an LED light source.

FIG. 2 is an example plot of a target load current of the LED driver of FIG. 1 as a function of a target intensity.

FIG. 3 is an example plot of a burst duty cycle of the LED driver of FIG. 1 as a function of the target intensity.

FIG. 4 is an example state diagram illustrating the operation of a load regulation circuit of the LED driver of FIG. 1 when operating in a burst mode.

FIG. 5 is a simplified schematic diagram of an isolated forward converter and a current sense circuit of an LED driver.

FIG. 6 is an example diagram illustrating a magnetic core set of an energy-storage inductor of a forward converter.

FIG. 7 shows example waveforms illustrating the operation of a forward converter and a current sense circuit when the intensity of an LED light source is near a high-end intensity.

FIG. 8 shows example waveforms illustrating the operation of a forward converter and a current sense circuit when the intensity of an LED light source is near a low-end intensity.

FIG. 9 is an example plot of a relationship between an offset time and a target intensity of an LED driver.

FIG. 10 is an example plot of an alternative relationship between the offset time and the target intensity of an LED driver.

FIG. 11 shows example waveforms illustrating the operation of a forward converter of an LED driver when operating in a burst mode.

FIG. 12A is a diagram of an example waveform illustrating the load current I_{LOAD} when a load regulation circuit is operating in a burst mode.

FIG. 12B is a diagram of an example waveform illustrating the load current I_{LOAD} when a load regulation circuit is operating in a burst mode.

FIG. 12C is example waveforms illustrating an example of how a load control circuit may determine the current offset when holding the active state period constant during burst mode.

FIG. 13 is an example of a plot relationship between a target load current and the burst duty cycle, and the target intensity of a light source.

FIG. 14A is an example waveform illustrating an overshoot in a load current conducted through a light source.

FIG. 14B is an example waveform illustrating control of a rise time of a load current conducted through a light source at the beginning of each active state period during burst mode.

FIGS. 15A, 15B, 16, 17A, 17B, and 18 are simplified flowcharts of example procedures for operating a forward converter of an LED driver in a normal mode and a burst mode.

### DETAILED DESCRIPTION

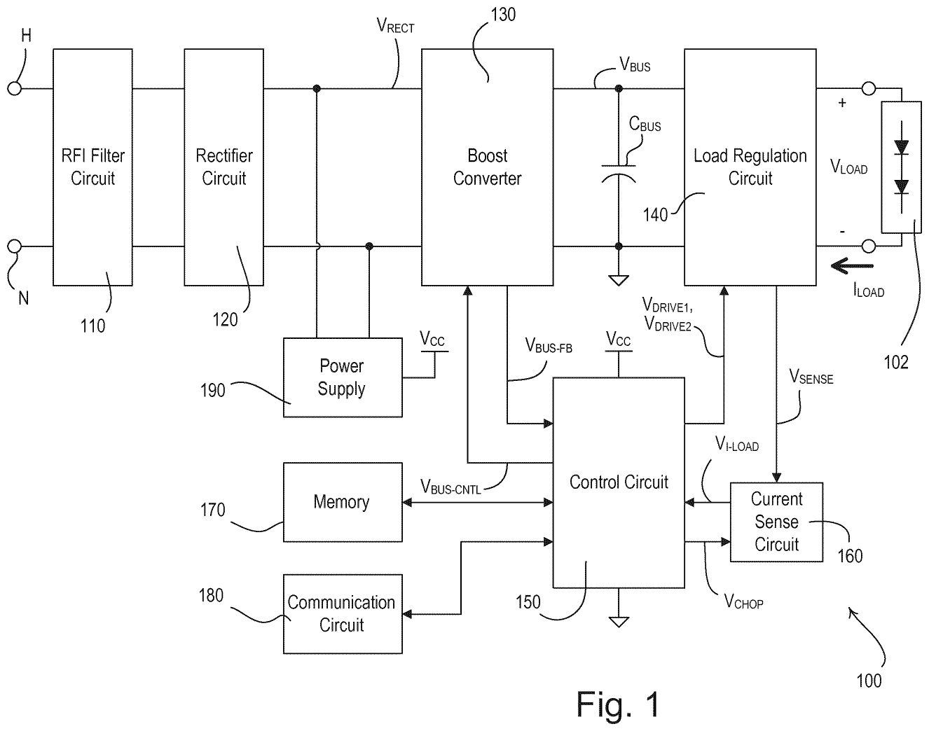

FIG. 1 is a simplified block diagram of a load control device, e.g., a light-emitting diode (LED) driver 100, for controlling the amount of power delivered to an electrical load, such as, an LED light source 102 (e.g., an LED light engine), and thus the intensity of the electrical load. The LED light source 102 is shown as a plurality of LEDs connected in series but may comprise a single LED or a plurality of LEDs connected in parallel or a suitable combination thereof, depending on the lighting system. The LED light source 102 may comprise one or more organic light-emitting diodes (OLEDs). The LED driver 100 may comprise a hot terminal H and a neutral terminal that are adapted to be coupled to an alternating-current (AC) power source (not shown).

The LED driver 100 may comprise a radio-frequency (RFI) filter circuit 110, a rectifier circuit 120, a boost converter 130, a load regulation circuit 140, a control circuit 150, a current sense circuit 160, a memory 170, a communication circuit 180, and/or a power supply 190. The RFI filter circuit 110 may minimize the noise provided on the AC mains. The rectifier circuit 120 may generate a rectified voltage V_{RECT}.

The boost converter 130 may receive the rectified voltage V_{RECT} and generate a boosted direct-current (DC) bus voltage V_{BUS} across a bus capacitor C_{BUS}. The boost converter 130 may comprise any suitable power converter circuit for generating an appropriate bus voltage, such as, for example, a flyback converter, a single-ended primary-inductor converter (SEPIC), a Ćuk converter, or other suitable power converter circuit. The boost converter 120 may operate as a power factor correction (PFC) circuit to adjust the power factor of the LED driver 100 towards a power factor of one.

The load regulation circuit 140 may receive the bus voltage V_{BUS} and control the amount of power delivered to the LED light source 102, for example, to control the intensity of the LED light source 102 between a low-end (i.e., minimum) intensity L_{LE} (e.g., approximately 1-5%) and a high-end (i.e., maximum) intensity L_{HE} (e.g., approximately 100%). An example of the load regulation circuit 140 may be an isolated, half-bridge forward converter. An example of the load control device (e.g., LED driver 100) comprising a forward converter is described in greater detail in commonly-assigned U.S. patent application Ser. No. 13/935,799, filed Jul. 5, 2013, entitled LOAD CONTROL DEVICE FOR A LIGHT-EMITTING DIODE LIGHT SOURCE, the entire disclosure of which is hereby incorporated by reference. The load regulation circuit 140 may comprise, for example, a buck converter, a linear regulator, or any suitable LED drive circuit for adjusting the intensity of the LED light source 102.

The control circuit 150 may be configured to control the operation of the boost converter 130 and/or the load regulation circuit 140. An example of the control circuit 150 may be a controller. The control circuit 150 may comprise, for example, a digital controller or any other suitable processing device, such as, for example, a microcontroller, a programmable logic device (PLD), a microprocessor, an application specific integrated circuit (ASIC), or a field-programmable gate array (FPGA). The control circuit 150 may generate a bus voltage control signal V_{BUS-CNTL}, which may be provided to the boost converter 130 for adjusting the magnitude of the bus voltage V_{BUS}. The control circuit 150 may receive a bus voltage feedback control signal V_{BUS-FB} from the boost converter 130, which may indicate the magnitude of the bus voltage V_{BUS}.

The control circuit 150 may generate drive control signals V_{DRIVE1}, V_{DRIVE2}. The drive control signals V_{DRIVE1}, V_{DRIVE2} may be provided to the load regulation circuit 140 for adjusting the magnitude of a load voltage V_{LOAD} generated across the LED light source 102 and the magnitude of a load current I_{LOAD} conducted through the LED light source 120, for example, to control the intensity of the LED light source 120 to a target intensity L_{TRGT}. The control circuit 150 may adjust an operating frequency fop and/or a duty cycle DC_{INV} (e.g., an on-time T_{ON}) of the drive control signals V_{DRIVE1}, V_{DRIVE}? to adjust the magnitude of the load voltage V_{LOAD} and/or the load current I_{LOAD}.

The current sense circuit 160 may receive a sense voltage V_{SENSE} generated by the load regulation circuit 140. The sense voltage V_{SENSE} may indicate the magnitude of the load current I_{LOAD}. The current sense circuit 160 may receive a signal-chopper control signal V_{CHOP} from the control circuit 150. The current sense circuit 160 may generate a load current feedback signal V_{I-LOAD}, which may be a DC voltage indicating the average magnitude I_{AVE} of the load current I_{LOAD}. The control circuit 150 may receive the load current feedback signal V_{I-LOAD} from the current sense circuit 160 and control the drive control signals V_{DRIVE1}, V_{DRIVE2} accordingly. For example, the control circuit 150 may control the drive control signals V_{DRIVE1}, V_{DRIVE2} to adjust a magnitude of the load current I_{LOAD} to a target load current I_{TRGT} to thus control the intensity of the LED light source 102 to the target intensity L_{TRGT} (e.g., using a control loop).

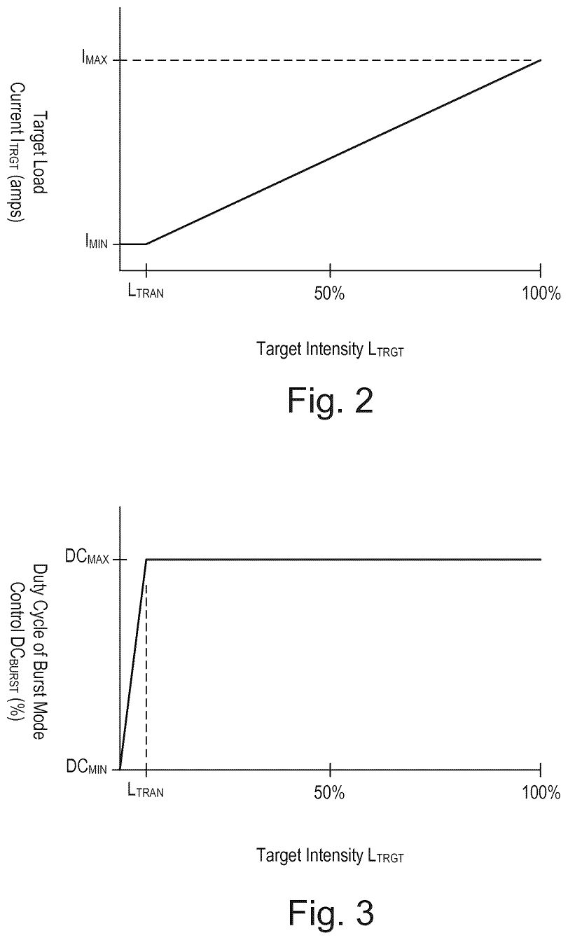

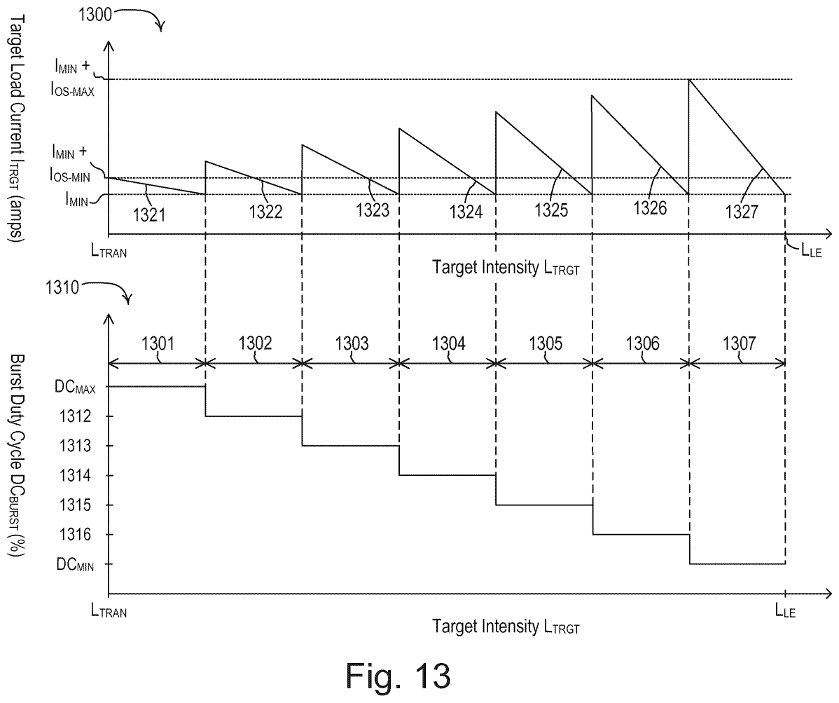

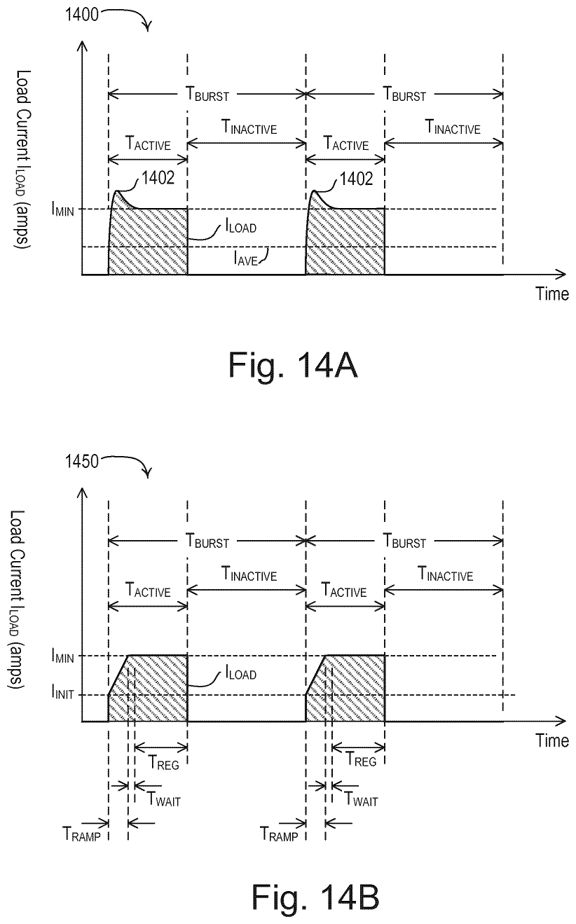

The load current I_{LOAD} may be the current that is conducted through the LED light source 120. The target load current I_{TRGT} may be the current that the control circuit 150 would ideally like to conduct through the LED light source 120 (e.g., based at least on the load current feedback signal V_{I-LOAD}). The control circuit 150 may be limited to specific levels of granularity in which it can control the current conducted through the LED light source 120 (e.g., due to inverter cycle lengths, etc.), so the control circuit 150 may not always be able to achieve the target load current I_{TRGT}. For example, FIGS. 2 and 13 illustrate the current conducted through an LED light source as a linear graph (at least in parts), and as such, illustrate the target load current I_{TRGT} since the load current I_{LOAD} itself may not actually follow a true linear path. Further, non-ideal reactions of the LED light source 120 (e.g., an overshoot in the load current I_{LOAD}, for example, as shown in FIG. 14A) may cause the load current I_{LOAD} to deviate from the target load current I_{TRGT}. In the ideal situation, the load current I_{LOAD} is approximately equal to the target load current I_{TRGT}.

The control circuit 150 may be coupled to the memory 170. The memory 170 may store operational characteristics of the LED driver 100 (e.g., the target intensity L_{TRGT}, the low-end intensity L_{LE}, the high-end intensity L_{HE}, etc.). The communication circuit 180 may be coupled to, for example, a wired communication link or a wireless communication link, such as a radio-frequency (RF) communication link or an infrared (IR) communication link. The control circuit 150 may be configured to update the target intensity L_{TRGT} of the LED light source 102 and/or the operational characteristics stored in the memory 170 in response to digital messages received via the communication circuit 180. The LED driver 100 may be operable to receive a phase-control signal from a dimmer switch for determining the target intensity L_{TRGT} for the LED light source 102. The power supply 190 may receive the rectified voltage V_{RECT} and generate a direct-current (DC) supply voltage V_{CC} for powering the circuitry of the LED driver 100.

FIG. 2 is an example plot of the target load current I_{TRGT} as a function of the target intensity L_{TRGT}. The magnitude of the load current I_{LOAD} may only be regulated to values between a maximum rated current I_{MAX} and a minimum rated current I_{MIN}, for example, due to hardware limitations of the load regulation circuit 140 and the control circuit 150. Thus, the target load current I_{TRGT} may only be adjusted between the maximum rated current I_{MAX} and the minimum rated current I_{MIN}. When the target intensity L_{TRGT} is between the high-end intensity L_{HE} (e.g., approximately 100%) and a transition intensity L_{TRAN} (e.g., approximately 5%), the control circuit 150 may operate the load regulation circuit 140 in a normal mode in which an average magnitude I_{AVE} of the load current I_{LOAD} is controlled to be equal to the target load current I_{TRGT}. In the normal mode, the control circuit 150 may adjust the average magnitude I_{AVE} of the load current I_{LOAD} to the target load current I_{TRGT} in response to the load current feedback signal V_{I-LOAD}, e.g., using closed loop control. The control circuit 150 may adjust the target load current I_{TRGT} between the maximum rated current I_{MAX} and the minimum rated current I_{MIN} in the normal mode, for example, as shown in FIG. 2.

FIG. 3 is an example plot of a burst duty cycle DC_{BURST} (e.g., an ideal burst duty cycle DC_{BURST-IDEAL}) as a function of the target intensity L_{TRGT}. When the target intensity L_{TRGT} is between the high-end intensity L_{HE} (e.g., approximately 100%) and a transition intensity L_{TRAN} (e.g., approximately 5%), the control circuit 150 may be configured to operate the load regulation circuit 140 to set the burst duty cycle DC_{BURST} equal to a maximum duty cycle DC_{MAX} (e.g., approximately 100%). To adjust the target intensity L_{TRGT} below the transition intensity L_{TRAN}, the control circuit 150 may be configured to operate the load regulation circuit 140 in a burst mode to reduce the average magnitude I_{AVE} of the load current I_{LOAD} to be less the minimum rated current I_{MIN}. For example, to adjust the target intensity L_{TRGT} below the transition intensity L_{TRAN}, the control circuit 150 may be configured to operate the load regulation circuit 140 to reduce the burst duty cycle DC_{BURST} below the maximum duty cycle DC_{MAX}. For example, the load regulation circuit 140 may adjust the burst duty cycle DC_{BURST} between the maximum duty cycle DC_{MAX} (e.g., approximately 100%) and a minimum duty cycle DC_{MIN} (e.g., approximately 20%). In the burst mode, a peak magnitude I_{PK} of the load current I_{LOAD} may be equal to the target current I_{TRGT} (e.g., the minimum rated current I_{MIN}). For example, the peak magnitude I_{PK} of the load current I_{LOAD} may be equal to the minimum rated current I_{MIN} during an active state of the burst mode.

With reference to FIG. 3, the burst duty cycle DC_{BURST} may refer to an ideal burst duty cycle DC_{BURST-IDEAL}, which may include an integer portion DC_{BURST-INTEGER} and/or a fractional portion DC_{BURST-FRACTIONAL}. The integer portion DC_{BURST-INTEGER} may be characterized by the percentage of the ideal burst duty cycle DC_{BURST-IDEAL} that includes complete inverter cycles (i.e., an integer value of inverter cycles). The fractional portion DC_{BURST-FRACTIONAL} may be characterized by the percentage of the ideal burst duty cycle DC_{BURST-IDEAL} that includes a fraction of an inverter cycle. As described herein, the control circuit 150 (e.g., via the load regulation circuit 140) may be configured to adjust the number of inverter cycles only by an integer number (i.e., by DC_{BURST-INTEGER}) and not a fractional amount (i.e., DC_{BURST-FRACTIONAL}). Therefore, the example plot of FIG. 3 may illustrate an ideal curve showing the adjustment of the ideal burst duty cycle DC_{BURST-IDEAL} from a maximum duty cycle DC_{MAX} to a minimum duty cycle DC_{MIN} when the target intensity L_{TRGT} is below the transition intensity L_{TRAN}. Nonetheless, unless defined differently, burst duty cycle DC_{BURST} may refer to the integer portion DC_{BURST-INTEGER} of the ideal burst duty cycle DC_{BURST-IDEAL}, for example, if the control circuit 150 is not to be configured to operate the burst duty cycle DC_{BURST} at fractional amounts.

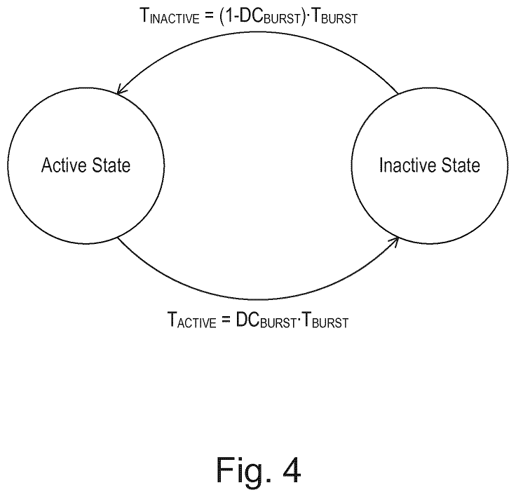

FIG. 4 is an example state diagram illustrating the operation of the load regulation circuit 140 in the burst mode. During the burst mode, the control circuit 150 may periodically control the load regulation circuit 140 into an active state and an inactive state, e.g., in dependence upon a burst duty cycle DC_{BURST} and a burst mode period T_{BURST} (e.g., approximately 4.4 milliseconds). For example, the active state period (T_{ACTIVE}) may be equal to the burst duty cycle (DC_{BURST}) times the burst mode period (T_{BURST}) and the inactive state period (T_{INACTIVE}) may be equal to one minus the burst duty cycle (DC_{BURST}) times the burst mode period (T_{BURST}). That is, T_{ACTIVE}=DC_{BURST}·T_{BURST} and T_{INACTIVE}=(1−DC_{BURST})·T_{BURST}.

In the active state of the burst mode, the control circuit 150 may generate (e.g., actively generate) the drive control signals V_{DRIVE1}, V_{DRIVE2} to adjust the magnitude (e.g., the peak magnitude I_{PK}) of the load current I_{LOAD}, e.g., using closed loop control. For example, in the active state of the burst mode, the control circuit 150 may generate the drive signals V_{DRIVE1}, V_{DRIVE2} to adjust the magnitude of the load current I_{LOAD} to be equal to a target load current I_{TRGT} (e.g., the minimum rated current I_{MIN}) in response to the load current feedback signal V_{I-LOAD}.

In the inactive state of the burst mode, the control circuit 150 may freeze the control loop and may not generate the drive control signals V_{DRIVE1}, V_{DRIVE2}, for example, such that the magnitude of the load current I_{LOAD} drops to approximately zero amps. While the control loop is frozen (e.g., in the inactive state), the control circuit 150 may not adjust the values of the operating frequency fop and/or the duty cycle DC_{INV} in response to the load current feedback signal V_{I-LOAD} (e.g., even though the control circuit 150 is not presently generating the drive signals V_{DRIVE1}, V_{DRIVE2}). For example, the control circuit 150 may store the present duty cycle DC_{INV} (e.g., the present on time T_{ON}) of the drive control signals V_{DRIVE1}, V_{DRIVE2} in the memory 170 prior to (e.g., immediately prior to) freezing the control loop. Accordingly, when the control loop is unfrozen (e.g., when the control circuit 150 enters the active state), the control circuit 150 may continue to generate the drive control signals V_{DRIVE1}, V_{DRIVE2} using the operating frequency fop and/or the duty cycle DC_{INV} from the previous active state.

The control circuit 150 may be configured to adjust the burst duty cycle DC_{BURST} using an open loop control. For example, the control circuit 150 may be configured to adjust the burst duty cycle DC_{BURST} as a function of the target intensity L_{TRGT}, for example, when the target intensity L_{TRGT} is below the transition intensity L_{TRAN}. The control circuit 150 may be configured to linearly decrease the burst duty cycle DC_{BURST} as the target intensity L_{TRGT} is decreased below the transition intensity L_{TRAN} (e.g., as shown in FIG. 3), while the target load current I_{TRGT} is held constant at the minimum rated current I_{MIN} (e.g., as shown in FIG. 2). Since the control circuit 150 changes between the active state and the inactive state in dependence upon the burst duty cycle DC_{BURST} and the burst mode period T_{BURST} (e.g., as shown in the state diagram of FIG. 4), the average magnitude I_{AVE} of the load current I_{LOAD} may be a function of the burst duty cycle DC_{BURST} (e.g., I_{AVE}=DC_{BURST}·I_{MIN}). During the burst mode, the peak magnitude I_{PK} of the load current I_{LOAD} may be equal to the minimum rated current I_{MIN}, but the average magnitude I_{AVE} of the load current I_{LOAD} may be less than the minimum rated current I_{MIN}.

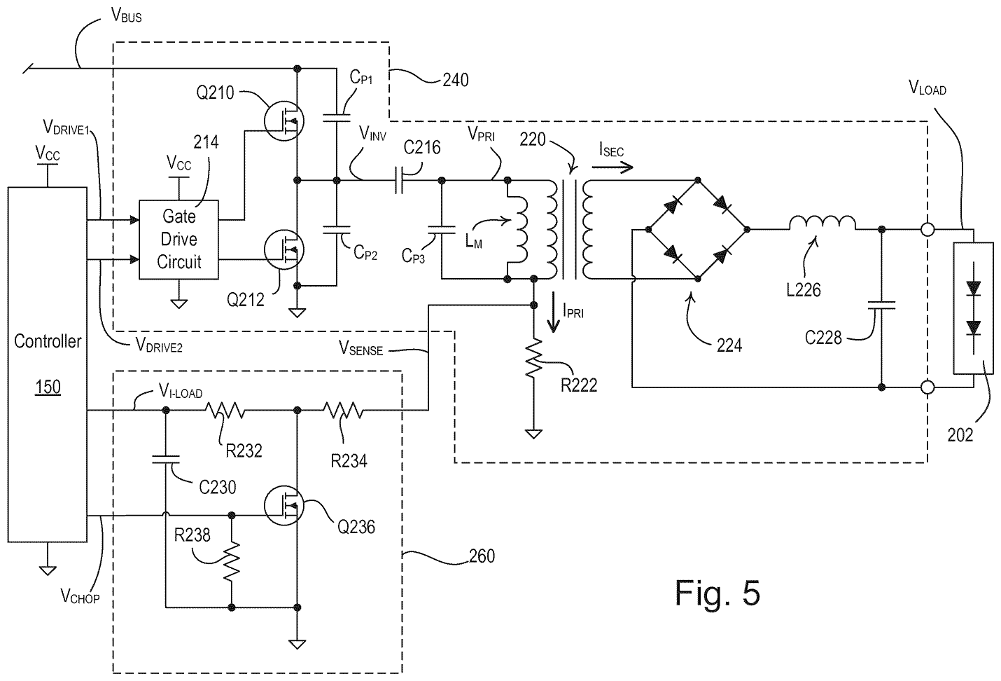

FIG. 5 is a simplified schematic diagram of a forward converter 240 and a current sense circuit 260 of an LED driver (e.g., the LED driver 100 shown in FIG. 1). The forward converter 240 may be an example of the load regulation circuit 140 of the LED driver 100 shown in FIG. 1. The current sense circuit 260 may be an example of the current sense circuit 160 of the LED driver 100 shown in FIG. 1.

The forward converter 240 may comprise a half-bridge inverter circuit having two field effect transistors (FETs) Q210, Q212 for generating a high-frequency inverter voltage V_{INV} from the bus voltage V_{BUS}. The FETs Q210, Q212 may be rendered conductive and non-conductive in response to the drive control signals V_{DRIVE1}, V_{DRIVE2}. The drive control signals V_{DRIVE1}, V_{DRIVE2} may be received from the control circuit 150. The drive control signals V_{DRIVE1}, V_{DRIVE2} may be coupled to the gates of the respective FETs Q210, Q212 via a gate drive circuit 214 (e.g., which may comprise part number L6382DTR, manufactured by ST Microelectronics). The control circuit 150 may generate the inverter voltage V_{INV} at a constant operating frequency fop (e.g., approximately 60-65 kHz) and thus a constant operating period T_{OP}. However, the operating frequency for may be adjusted under certain operating conditions. The control circuit 150 may be configured to adjust a duty cycle DC_{INV} of the inverter voltage V_{INV} to control the intensity of an LED light source 202 toward the target intensity L_{TRGT}.

In a normal mode of operation, when the target intensity L_{TRGT} of the LED light source 202 is between the high-end intensity L_{HE} and the transition intensity L_{TRAN}, the control circuit 150 may adjust the duty cycle DC_{INV} of the inverter voltage V_{INV} to adjust the magnitude (e.g., the average magnitude I_{AVE}) of the load current I_{LOAD} towards the target load current I_{TRGT}. As previously mentioned, the magnitude of the load current I_{LOAD} may vary between the maximum rated current I_{MAX} and the minimum rated current I_{MIN} (e.g., as shown in FIG. 2). At the minimum rated current I_{MIN} (e.g., at the transition intensity L_{TRAN}), the inverter voltage V_{INV} may be characterized by a transition operating frequency f_{OP-T}, a transition operating period T_{OP-T}, and a transition duty cycle DC_{INV-T}.

When the target intensity L_{TRGT} of the LED light source 202 is below the transition intensity L_{TRAN}, the control circuit 150 may be configured to operate the forward converter 240 in a burst mode of operation. In one or more embodiments, the control circuit 150 may use power (e.g., a transition power) and/or current (e.g., a transition current) as a threshold to determine when to operate in burst mode (e.g., instead of intensity). In the burst mode of operation, the control circuit 150 may be configured to switch the forward converter 240 between an active mode (e.g., in which the control circuit 150 actively generates the drive control signals V_{DRIVE1}, V_{DRIVE2} to regulate the peak magnitude I_{PK} of the load current I_{LOAD} to be equal to the minimum rated current I_{MIN}) and an inactive mode (e.g., in which the control circuit 150 freezes the control loop and does not generate the drive control signals V_{DRIVE1}, V_{DRIVE2}), for example, as shown in the state diagram of FIG. 4. In the burst mode, the control circuit 150 may change the forward converter 240 between the active state and the inactive state in dependence upon a burst duty cycle DC_{BURST} and a burst mode period T_{BURST} (e.g., as shown in FIG. 4) and adjust the burst duty cycle DC_{BURST} as a function of the target intensity L_{TRGT}, which is below the transition intensity L_{TRAN} (e.g., as shown in FIG. 3). In the normal mode and in the active state of the burst mode, the forward converter 240 may be characterized by a turn-on time T_{TURN-ON} and a turn-off time T_{TURN-OFF}. The turn-on time T_{TURN-ON} may be a time period from when the drive control signals V_{DRIVE1}, V_{DRIVE2} are driven until the respective FET Q210, Q212 is rendered conductive. The turn-off time T_{TURN-OFF} may be a time period from when the drive control signals V_{DRIVE1}, V_{DRIVE2} are driven until the respective FET Q210, Q212 is rendered non-conductive.

The inverter voltage V_{INV} is coupled to the primary winding of a transformer 220 through a DC-blocking capacitor C216 (e.g., which may have a capacitance of approximately 0.047 μF), such that a primary voltage V_{PRI} is generated across the primary winding. The transformer 220 may be characterized by a turns ratio n_{TURNS} (i.e., N₁/N₂), which may be approximately 115:29. A sense voltage V_{SENSE} may be generated across a sense resistor R222, which may be coupled in series with the primary winding of the transformer 220. The FETs Q210, Q212 and the primary winding of the transformer 220 may be characterized by parasitic capacitances C_{P1}, C_{P2}, C_{P3}, respectively. The secondary winding of the transformer 220 may generate a secondary voltage. The secondary voltage may be coupled to the AC terminals of a full-wave diode rectifier bridge 224 for rectifying the secondary voltage generated across the secondary winding. The positive DC terminal of the rectifier bridge 224 may be coupled to the LED light source 202 through an output energy-storage inductor L226 (e.g., which may have an inductance of approximately 10 mH), such that the load voltage V_{LOAD} may be generated across an output capacitor C228 (e.g., which may have a capacitance of approximately 3 μF).

The current sense circuit 260 may comprise an averaging circuit for producing the load current feedback signal V_{I-LOAD}. The averaging circuit may comprise a low-pass filter comprising a capacitor C230 (e.g., which may have a capacitance of approximately 0.066 uF) and a resistor R232 (e.g., which may have a resistance of approximately 3.32 kΩ). The low-pass filter may receive the sense voltage V_{SENSE} via a resistor R234 (e.g., which may have a resistance of approximately 1 kΩ). The current sense circuit 160 may comprise a transistor Q236 (e.g., a FET as shown in FIG. 5) coupled between the junction of the resistors R232, R234 and circuit common. The gate of the transistor Q236 may be coupled to circuit common through a resistor R238 (e.g., which may have a resistance of approximately 22 kΩ. The gate of the transistor Q236 may receive the signal-chopper control signal V_{CHOP} from the control circuit 150. An example of the current sense circuit 260 may be described in greater detail in commonly-assigned U.S. patent application Ser. No. 13/834,153, filed Mar. 15, 2013, entitled FORWARD CONVERTER HAVING A PRIMARY-SIDE CURRENT SENSE CIRCUIT, the entire disclosure of which is hereby incorporated by reference.

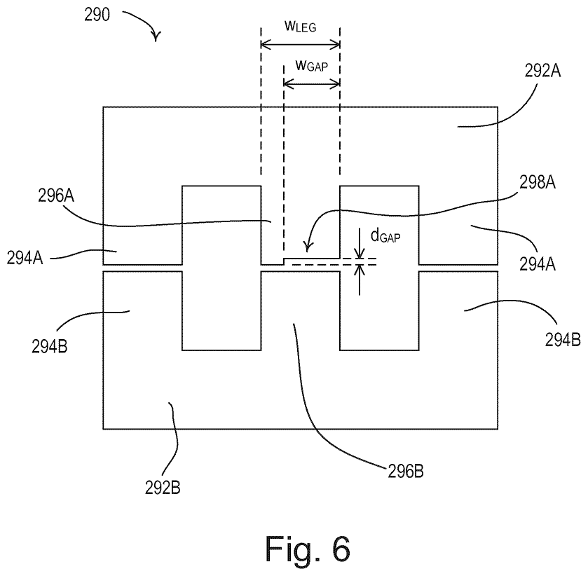

FIG. 6 is an example diagram illustrating a magnetic core set 290 of an energy-storage inductor (e.g., the output energy-storage inductor L226 of the forward converter 240 shown in FIG. 5). The magnetic core set 290 may comprise two E-cores 292A, 292B, and may comprise part number PC40EE16-Z, manufactured by TDK Corporation. The E-cores 292A, 292B may comprise respective outer legs 294A, 294B and inner legs 296A, 296B. Each inner leg 296A, 296B may be characterized by a width w_{LEG} (e.g., approximately 4 mm). The inner leg 296A of the first E-core 292A may comprise a partial gap 298A (i.e., the magnetic core set 290 is partially gapped), such that the inner legs 296A, 296B are spaced apart by a gap distance d_{GAP} (e.g., approximately 0.5 mm). The partial gap 298A may extend for a gap width w_{GAP} (e.g., approximately 2.8 mm) such that the partial gap 298A extends for approximately 70% of the leg width w_{LEG} of the inner leg 296A. In one or more embodiments, both of the inner legs 296A, 296B may comprise partial gaps. The partially-gapped magnetic core set 290 (e.g., as shown in FIG. 6) may allow the output energy-storage inductor L226 of the forward converter 240 (e.g., shown in FIG. 5) to maintain continuous current at low load conditions (e.g., near the low-end intensity L_{LE}).

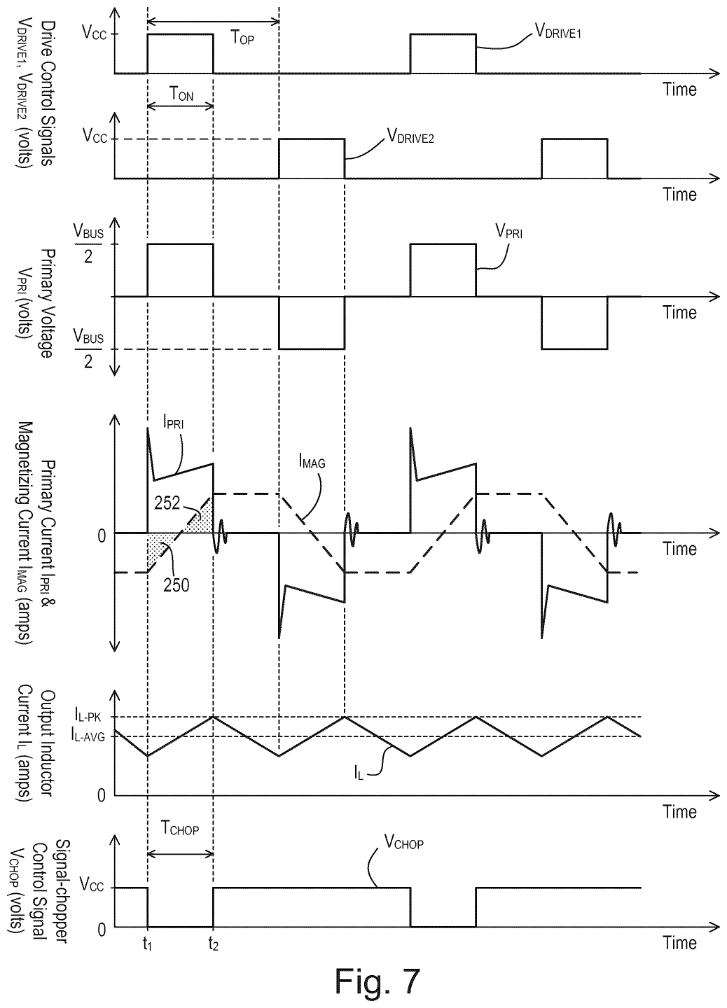

FIG. 7 shows example waveforms illustrating the operation of a forward converter and a current sense circuit, for example, the forward converter 240 and the current sense circuit 260 shown in FIG. 5. For example, the forward converter 240 may generate the waveforms shown in FIG. 7 when operating in the normal mode and in the active state of the burst mode as described herein. As shown in FIG. 7, a control circuit (e.g., the control circuit 150) may drive the respective drive control signals V_{DRIVE1}, V_{DRIVE2} high to approximately the supply voltage V_{CC} to render the respective FETs Q210, Q212 conductive for an on-time T_{ON} at different times (i.e., the FETs Q210, Q212 are conductive at different times). When the high-side FET Q210 is conductive, the primary winding of the transformer 220 may conduct a primary current I_{PRI} to circuit common through the capacitor C216 and sense resistor R222. After (e.g., immediately after) the high-side FET Q210 is rendered conductive (at time t₁ in FIG. 7), the primary current I_{PRI} may conduct a short high-magnitude pulse of current due to the parasitic capacitance C_{P3} of the transformer 220 as shown in FIG. 7. While the high-side FET Q210 is conductive, the capacitor C216 may charge, such that a voltage having a magnitude of approximately half of the magnitude of the bus voltage V_{BUS} is developed across the capacitor. Accordingly, the magnitude of the primary voltage V_{PRI} across the primary winding of the transformer 220 may be equal to approximately half of the magnitude of the bus voltage V_{BUS} (i.e., V_{BUS}/2). When the low-side FET Q212 is conductive, the primary winding of the transformer 220 may conduct the primary current I_{PRI} in an opposite direction and the capacitor C216 may be coupled across the primary winding, such that the primary voltage V_{PRI} may have a negative polarity with a magnitude equal to approximately half of the magnitude of the bus voltage V_{BUS}.

When either of the high-side and low-side FETs Q210, Q212 are conductive, the magnitude of an output inductor current I_{L} conducted by the output inductor L226 and the magnitude of the load voltage V_{LOAD} across the LED light source 202 may increase with respect to time. The magnitude of the primary current I_{PRI} may increase with respect to time while the FETs Q210, Q212 are conductive (e.g., after an initial current spike). When the FETs Q210, Q212 are non-conductive, the output inductor current I_{L} and the load voltage V_{LOAD} may decrease in magnitude with respective to time. The output inductor current I_{L} may be characterized by a peak magnitude I_{L-PK} and an average magnitude I_{L-AVG}, for example, as shown in FIG. 7. The control circuit 150 may increase and/or decrease the on-times T_{ON} of the drive control signals V_{DRIVE1}, V_{DRIVE2} (e.g., and the duty cycle DC_{INV} of the inverter voltage V_{INV}) to respectively increase and decrease the average magnitude I_{L-AVG} of the output inductor current I_{L}, and thus respectively increase and decrease the intensity of the LED light source 202.

When the FETs Q210, Q212 are rendered non-conductive, the magnitude of the primary current I_{PRI} may drop toward zero amps (e.g., as shown at time t₂ in FIG. 7 when the high-side FET Q210 is rendered non-conductive). However, a magnetizing current I_{MAG} may continue to flow through the primary winding of the transformer 220 due to the magnetizing inductance L_{MAG} of the transformer. When the target intensity L_{TRGT} of the LED light source 102 is near the low-end intensity L_{LE}, the magnitude of the primary current I_{PRI} may oscillate after either of the FETs Q210, Q212 is rendered non-conductive, for example, due to the parasitic capacitances C_{P1}, C_{P2} of the FETs, the parasitic capacitance C_{P3} of the primary winding of the transformer 220, and/or any other parasitic capacitances of the circuit, such as, parasitic capacitances of the printed circuit board on which the forward converter 240 is mounted.

The real component of the primary current I_{PRI} may indicate the magnitude of the secondary current I_{SEC} and thus the intensity of the LED light source 202. However, the magnetizing current I_{MAG} (i.e., the reactive component of the primary current I_{PRI}) may also flow through the sense resistor R222. The magnetizing current I_{MAG} may change from a negative polarity to a positive polarity when the high-side FET Q210 is conductive, change from a positive polarity to a negative polarity when the low-side FET Q212 is conductive, and remain constant when the magnitude of the primary voltage V_{PRI} is zero volts, for example, as shown in FIG. 7. The magnetizing current I_{MAG} may have a maximum magnitude defined by the following equation:

$${I}_{MAG - MAX} = \frac{{V}_{B U S} \cdot {T}_{H C}}{4 \cdot {L}_{M A G}} , \qquad ( Eq . 1 )$$

where T_{HC} may be the half-cycle period of the inverter voltage V_{INV}, i.e., T_{HC}=T_{OP}/2. As shown in FIG. 7, the areas 250, 252 are approximately equal, such that the average value of the magnitude of the magnetizing current I_{MAG} is zero during the period of time when the magnitude of the primary voltage V_{PRI} is greater than approximately zero volts (e.g., during the on-time T_{ON} as shown in FIG. 7).

The current sense circuit 260 may determine an average the primary current I_{PRI} during the positive cycles of the inverter voltage V_{INV}, i.e., when the high-side FET Q210 is conductive (e.g., during the on-time T_{ON}). The load current feedback signal V_{I-LOAD}, which may be generated by the current sense circuit 260, may have a DC magnitude that is the average value of the primary current I_{PRI} when the high-side FET Q210 is conductive. Because the average value of the magnitude of the magnetizing current I_{MAG} is approximately zero during the period of time that the high-side FET Q210 is conductive (e.g., during the on-time T_{ON}), the load current feedback signal V_{I-LOAD} generated by the current sense circuit indicates the real component (e.g., only the real component) of the primary current I_{PRI} during the on-time TON.

When the high-side FET Q210 is rendered conductive, the control circuit 150 may drive the signal-chopper control signal V_{CHOP} low towards circuit common to render the transistor Q236 of the current sense circuit 260 non-conductive for a signal-chopper time T_{CHOP}. The signal-chopper time T_{CHOP} may be approximately equal to the on-time T_{ON} of the high-side FET Q210, for example, as shown in FIG. 7. The capacitor C230 may charge from the sense voltage V_{SENSE} through the resistors R232, R234 while the signal-chopper control signal V_{CHOP} is low, such that the magnitude of the load current feedback signal V_{I-LOAD} is the average value of the primary current I_{PRI} and thus indicates the real component of the primary current during the time when the high-side FET Q210 is conductive. When the high-side FET Q210 is not conductive, the control circuit 150 drives the signal-chopper control signal V_{CHOP} high to render the transistor Q236 conductive. Accordingly, the control circuit 150 is able to accurately determine the average magnitude of the load current I_{LOAD} from the magnitude of the load current feedback signal V_{I-LOAD} since the effects of the magnetizing current I_{MAG} and the oscillations of the primary current I_{PRI} on the magnitude of the load current feedback signal V_{I-LOAD} are reduced or eliminated completely.

As the target intensity L_{TRGT} of the LED light source 202 is decreased toward the low-end intensity L_{LE} and the on-times T_{ON} of the drive control signals V_{DRIVE1}, V_{DRIVE2} get smaller, the parasitic of the load regulation circuit 140 (i.e., the parasitic capacitances C_{P1}, C_{P2} of the FETs Q210, Q212, the parasitic capacitance C_{P3} of the primary winding of the transformer 220, and/or other parasitic capacitances of the circuit) may cause the magnitude of the primary voltage V_{PRI} to slowly decrease towards zero volts after the FETs Q210, Q212 are rendered non-conductive.

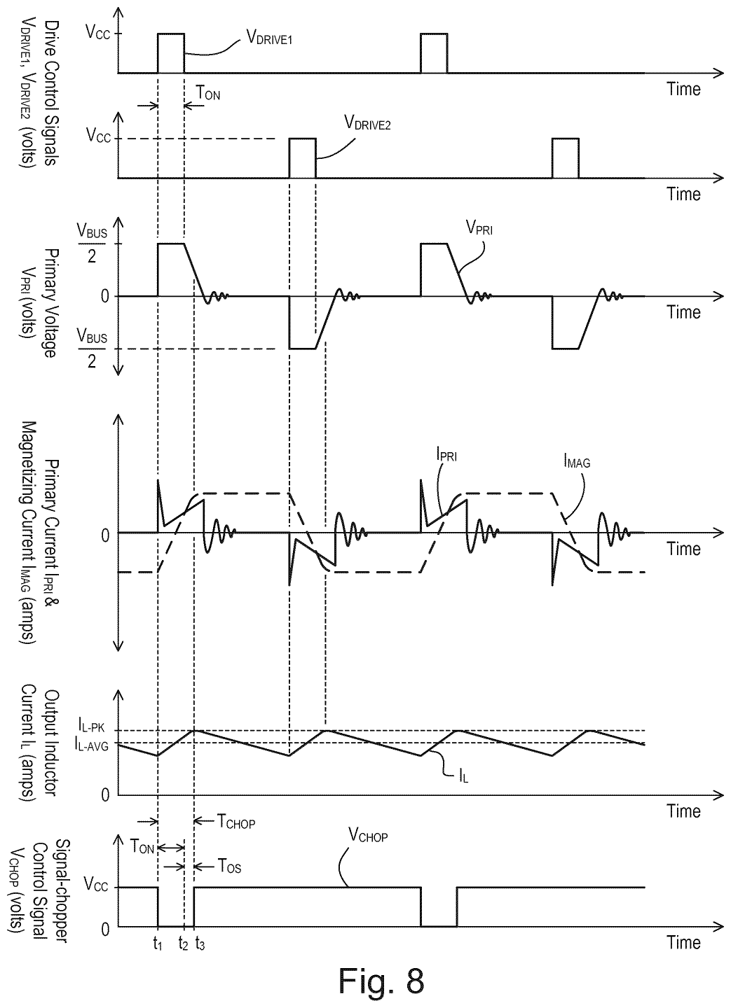

FIG. 8 shows example waveforms illustrating the operation of a forward converter and a current sense circuit (e.g., the forward converter 240 and the current sense circuit 260) when the target intensity L_{TRGT} is near the low-end intensity L_{LE}, and when the forward converter 240 is operating in the normal mode and the active state of the burst mode. The gradual drop-off in the magnitude of the primary voltage V_{PRI} may allow the primary winding of the transformer 220 to continue to conduct the primary current I_{PRI}, such that the transformer 220 may continue to deliver power to the secondary winding after the FETs Q210, Q212 are rendered non-conductive, for example, as shown in FIG. 8. The magnetizing current I_{MAG} may continue to increase in magnitude after the on-time T_{ON} of the drive control signal V_{DRIVE1} (e.g., and/or the drive control signal V_{DRIVE2}). Accordingly, the control circuit 150 may increase the signal-chopper time T_{CHOP} to be greater than the on-time T_{ON}. For example, the control circuit 150 may increase the signal-chopper time T_{CHOP} (e.g., during which the signal-chopper control signal V_{CHOP} is low) by an offset-time T_{OS} when the target intensity L_{TRGT} of the LED light source 202 is near the low-end intensity L_{LE}.

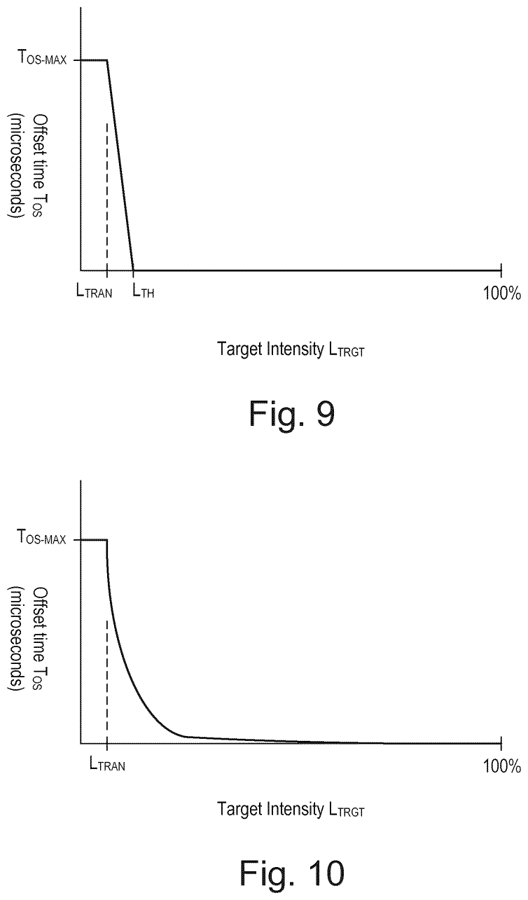

FIG. 9 is an example plot of a relationship between the offset-time T_{OS} and the target intensity L_{TRGT} of the LED light source 202, for example, when the target intensity L_{TRGT} is near the low-end intensity L_{LE}, and when the forward converter 240 is operating in the normal mode and the active state of the burst mode (e.g., as shown in FIG. 8). The control circuit 150 may adjust the value of the offset-time T_{OS} as a function of the target intensity L_{TRGT} of the LED light source 202. For example, the control circuit 150 may adjust the value of the offset-time T_{OS} linearly with respect to the target intensity L_{TRGT} when the target intensity L_{TRGT} is below a threshold intensity L_{TH} (e.g., approximately 10%) and above a transition intensity L_{TRAN} (e.g., approximately 5%). Above the threshold intensity L_{TH}, the offset-time T_{OS} may be held constant, for example, at approximately zero microseconds. Below the transition intensity L_{TRAN}, the offset-time T_{OS} may be held constant at a maximum offset-time T_{OS-MAX}, for example, because the target load current I_{TRGT} may be held constant at the minimum rated current I_{MIN} below the transition intensity L_{TRAN}.

FIG. 10 is an example plot of a relationship (e.g., an alternate relationship) between the offset time T_{OS} and the target intensity L_{TRGT} of the LED light source 202, for example, when the target intensity L_{TRGT} is near the low-end intensity L_{LE}, and when the forward converter 240 is operating in the normal mode and the active state of the burst mode (e.g., as shown in FIG. 8). The control circuit 150 may adjust the value of the offset time T_{OS} as a function of the target intensity L_{TRGT} of the LED light source 202. For example, the control circuit 150 may adjust the value of the offset time T_{OS} between the high-end intensity L_{HE} and the transition intensity L_{TRAN}, for example, as shown in FIG. 10. For example, the control circuit 150 may use the following equation:

$${T}_{OS} = \frac{\frac{{V}_{BUS}}{4} \cdot {C}_{PARASITIC}}{\frac{{T}_{ON} + {T}_{OS - PREV}}{{T}_{HC}} \cdot {I}_{MAG - MAX} + \frac{{K}_{RIPPLE}}{{n}_{TURNS}} \cdot {I}_{LOAD}} , \qquad ( Eq . 2 )$$

where T_{OS-PREV} may be the previous value of the offset time. K_{RIPPLE} may be the dynamic ripple ratio of the output inductor current I_{L} (e.g., which may be a function of the load current I_{LOAD}). For example, K_{RIPPLE} may be determined according to the following equation:

$${K}_{RIPPLE} = \frac{{I}_{L - PK}}{{I}_{L - AVG}} \qquad ( Eq . 3 )$$

and C_{PARASITIC} may be the total parasitic capacitance between the junction of the FETs Q210, Q212 and circuit common. Below the transition intensity L_{TRAN}, the offset time T_{OS} may be held constant at a maximum offset time T_{OS-MAX}.

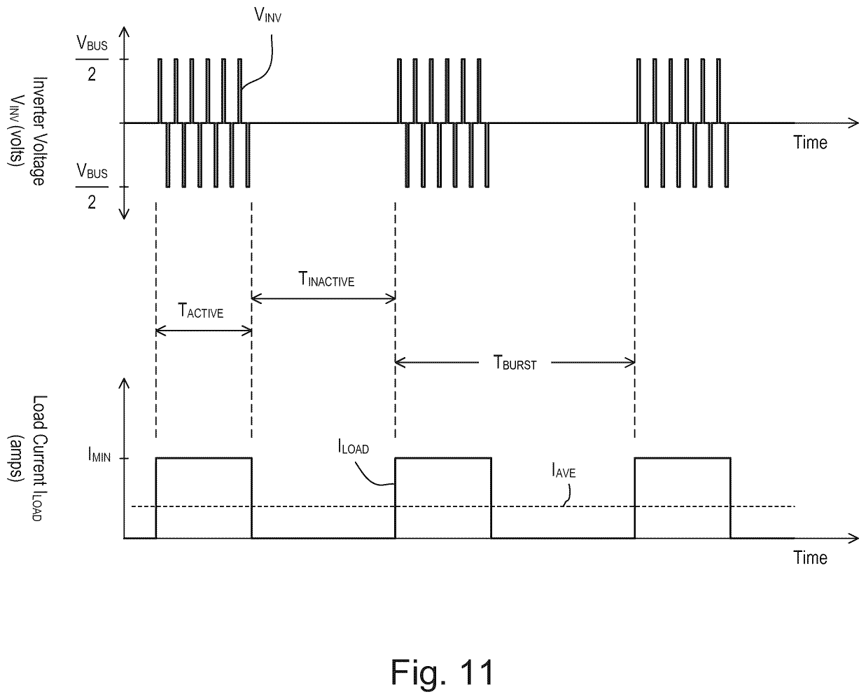

FIG. 11 shows example waveforms illustrating the operation of a forward converter when operating in a burst mode (e.g., the forward converter 240 shown in FIG. 5). The inverter circuit of the forward converter 240 may generate the inverter voltage V_{INV} during the active state (e.g., for length of an active-state period T_{ACTIVE} as shown in FIG. 11), for example, such that the magnitude of the load current I_{LOAD} may be regulated to the minimum-rated current I_{MIN}. The inverter voltage V_{INV} may not be generated during the inactive state, e.g., for an inactive-state period T_{INACTIVE}. The active state may begin on a periodic basis at a burst-mode period T_{BURST} (e.g., approximately 4.4 milliseconds). The active-state period T_{ACTIVE} and inactive-state period T_{INACTIVE} may be characterized by durations that are dependent upon a burst duty cycle DC_{BURST}. For example, T_{ACTIVE}=DC_{BURST}·T_{BURST} and T_{INACTIVE}=(1−DC_{BURST})·T_{BURST}. The average magnitude I_{AVE} of the load current I_{LOAD} may be dependent on the burst duty cycle DC_{BURST}. For example, the average magnitude I_{AVE} of the load current I_{LOAD} may equal the burst duty cycle DC_{BURST} times the load current I_{LOAD} (e.g., I_{AVE}=DC_{BURST}·I_{LOAD}), which in one example may be the minimum load current I_{MIN} (e.g., I_{AVE}=DC_{BURST}·I_{MIN}).

The burst duty cycle DC_{BURST} may be controlled to adjust the average magnitude I_{AVE} of the load current I_{LOAD}. For example, the burst-mode period T_{BURST} may be held constant and the length of the active-state period T_{ACTIVE} may be varied to adjust the duty cycle DC_{BURST}, which in turn may vary the average magnitude I_{AVE} of the load current I_{LOAD}. The active-state period T_{ACTIVE} may be held constant, and the length of burst-mode period T_{BURST} may be varied to adjust the burst duty cycle DC_{BURST}, which in turn may vary the average magnitude I_{AVE} of the load current I_{LOAD}. Accordingly, as the burst duty cycle DC_{BURST} is increased, the average magnitude I_{AVE} of the load current I_{LOAD} may increase, and as the burst duty cycle DC_{BURST} is decreased, the average magnitude I_{AVE} of the load current I_{LOAD} may decrease.

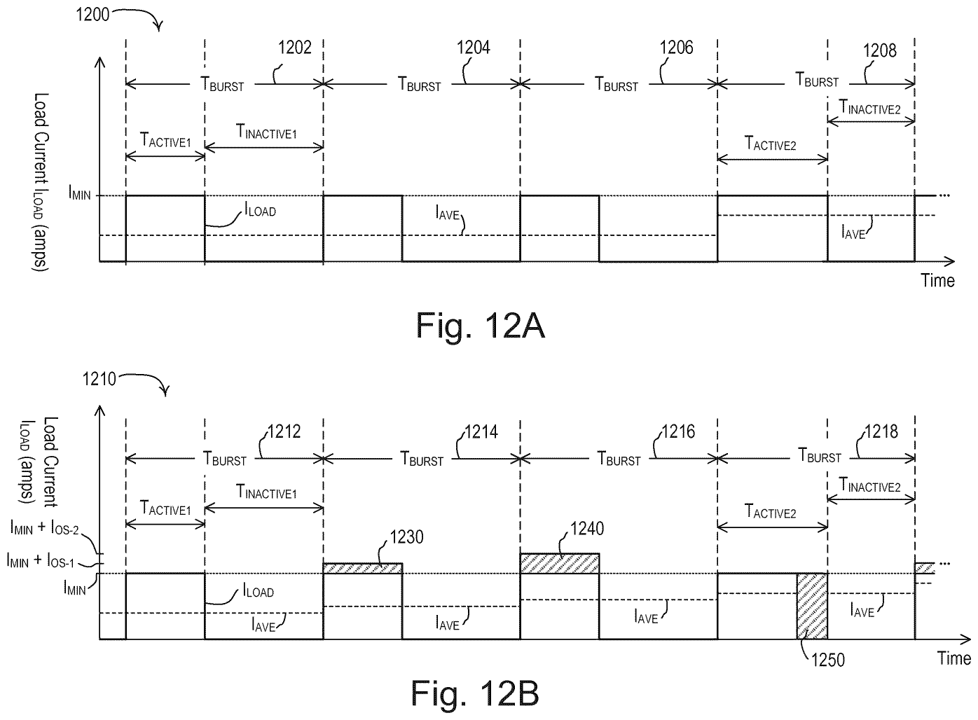

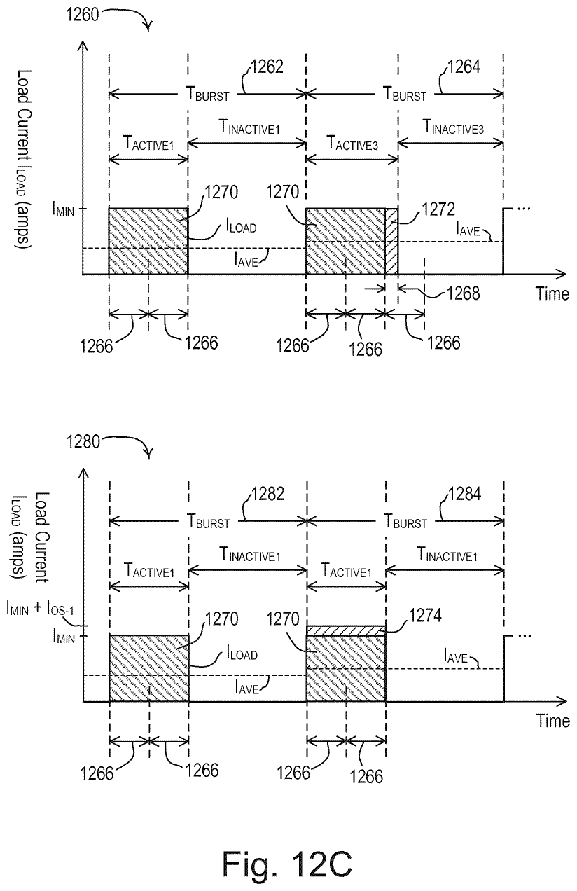

FIG. 12A is a diagram of an example waveform 1200 illustrating the load current I_{LOAD} when a load regulation circuit (e.g., the load regulation circuit 140) is operating in a burst mode, for example, as the target intensity L_{TRGT} of a light source (e.g., the LED light source 202) is increased (e.g., from the low-end intensity L_{LE}). A control circuit (e.g., the control circuit 150 of the LED driver 100 shown in FIG. 1 and/or the control circuit 150 controlling the forward converter 240 and the current sense circuit 260 shown in FIG. 5) may adjust the length of the active state period T_{ACTIVE} of the burst mode period T_{BURST} by adjusting the burst duty cycle DC_{BURST}. Adjusting the length of the active-state period T_{ACTIVE} may adjust the average magnitude I_{AVE} of the load current I_{LOAD}, and in turn the intensity of the light source.

The active-state period T_{ACTIVE} of the load current I_{LOAD} may have a length that is dependent upon the length of an inverter cycle of the inverter circuit of the load regulation circuit (i.e., the operating period T_{OP}). For example, referring to FIG. 11, the active-state period T_{ACTIVE} may comprise six inverter cycles, and as such, has a length that is equal to the duration of the six inverter cycles. The control circuit may adjust (i.e., increase or decrease) the active-state periods T_{ACTIVE} by adjusting the number of inverter cycles in the active-state period T_{ACTIVE}. As such, the control circuit may adjust the active-state periods T_{ACTIVE} by predetermined time intervals that correspond to the length of an inverter cycle of the inverter circuit of the load regulation circuit, for example, the transition operating period T_{OP-T} (e.g., approximately 12.8 microseconds). Therefore, the active-state period T_{ACTIVE} may be characterized by one or more inverter cycles, and may be adjusted by adjusting a number of inverter cycles per active-state period T_{ACTIVE}. As such, the average magnitude I_{AVE} of the load current I_{LOAD} may be adjusted by predetermined increments, for example, corresponding to a change in load current I_{LOAD} due to an increase or decrease of an inverter cycle per active-state period T_{ACTIVE}.

One or more burst-mode periods T_{BURST} of the load regulation circuit may be characterized by active-state periods T_{ACTIVE} that comprise the same number of inverter cycles. In the example of FIG. 12A, three burst-mode periods T_{BURST} 1202, 1204, 1206 may be characterized by equivalent active-state periods T_{ACTIVE1} (i.e., active-state periods T_{ACTIVE1} that have the same number of inverter cycles). The active-state period T_{ACTIVE2} of the burst-mode period T_{BURST} 1208 may be larger than the active-state periods T_{ACTIVE1} of the other burst-mode periods T_{BURST} 1202, 1204, 1206. In other words, the active-state period T_{ACTIVE2} during the burst-mode period T_{BURST} 1208 may be increased as compared to the active-state periods T_{ACTIVE1} during the burst-mode periods T_{BURST} 1202, 1204, 1206. As such, the average magnitude I_{AVE} of the load current I_{LOAD} may be increased in accordance with the additional inverter cycle(s) of the active-state period T_{ACTIVE2} during the burst-mode period T_{BURST} 1208. Therefore, the control circuit may adjust (i.e., increase or decrease) the average magnitude I_{AVE} of the load current I_{LOAD} by adjusting the active-state period T_{ACTIVE} by increments of one or more inverter cycles.

FIG. 12B is a diagram of an example waveform 1210 illustrating the load current I_{LOAD} when a load regulation circuit (e.g., the load regulation circuit 140) is operating in a burst mode, for example, as the target intensity L_{TRGT} of a light source (e.g., the LED light source 202) is increased (e.g., from the low-end intensity L_{LE}). As noted herein, a control circuit (e.g., the control circuit 150 of the LED driver 100 shown in FIG. 1 and/or the control circuit 150 controlling the forward converter 240 and the current sense circuit 260 shown in FIG. 5) may adjust the average magnitude I_{AVE} of the load current I_{LOAD} by adjusting the active-state period T_{ACTIVE} (i.e., the number of inverter cycles per active-state period T_{ACTIVE}). When adjusting only the active-state period T_{ACTIVE} (e.g., and in turn the burst duty cycle DC_{BURST}) near the low-end intensity L_{LE}, the adjustment of the average magnitude I_{AVE} of the load current I_{LOAD} may cause changes in the intensity of the lighting load that are visibly perceptible to the user (e.g., as shown in FIG. 12A).

The control circuit may also adjust (i.e., increase or decrease) the magnitude of the load current I_{LOAD} between and/or during adjustments of the active-state period T_{ACTIVE} while in the burst mode, for example, to adjust the average magnitude I_{AVE} of the load current I_{LOAD} with finer granularity as compared to adjusting only the active-state period T_{ACTIVE} (e.g., to provide finer tuning of the intensity of the lighting load). The control circuit may adjust (i.e., increase or decrease) the magnitude of the load current I_{LOAD} by adjusting the target load current I_{TRGT} and by controlling the inverter circuit to regulate the load current I_{LOAD} to the target load current I_{TRGT} during the active-state periods T_{ACTIVE}, for example, as described herein. The control circuit may adjust the load current I_{LOAD} linearly, variably as a function of the average magnitude I_{AVE} of the load current I_{LOAD}, and/or by predetermined amounts. As such, the control circuit may case the transitions between adjustments of the active-state period T_{ACTIVE} by adjusting the load current I_{LOAD}.

The control circuit may adjust the target load current I_{TRGT} by a current offset I_{OS}, for example, between adjustments of the active-state period T_{ACTIVE} and/or when adjusting the active-state period T_{ACTIVE}. The current offset I_{OS} may range (i.e., vary) between a minimum current offset I_{OS-MIN} and a maximum current offset I_{OS-MAX}, for example, based on the burst duty cycle DC_{BURST}. The value of the current offset I_{OS} may be determined based on the minimum rated current I_{MIN}, the target current I_{TRGT}, the target intensity L_{TRGT}, the burst duty cycle DC_{BURST}, and/or the active-state period T_{ACTIVE}. The current offset I_{OS} may be variable between burst mode periods T_{BURST} having the same active-state period T_{ACTIVE} and/or between burst-mode periods T_{BURST} having the different active-state periods T_{ACTIVE}.

Referring to FIG. 12B, the control circuit may increase the intensity of the light source at a constant rate. The control circuit may hold the active-state period T_{ACTIVE} of two or more burst-mode periods T_{BURST} constant, and may adjust the load current I_{LOAD} of the active-state periods T_{ACTIVE} of the two or more burst-mode periods T_{BURST}, for example, by a consistent or varying current offset I_{OS}. For example, the control circuit may hold the active-state period T_{ACTIVE1} (i.e., the number of inverter cycles of the active-state period T_{ACTIVE1}) of the burst-mode periods T_{BURST} 1212, 1214, 1216 constant as shown in FIG. 12B. The control circuit may set the load current I_{LOAD} during the active-state period T_{ACTIVE1} of the burst-mode period T_{BURST} 1212 to the minimum-rated current I_{MIN}. The control circuit may increase the load current I_{LOAD} of the active-state period T_{ACTIVE1} of the burst-mode period T_{BURST} 1214 by a current offset I_{OS-1} while holding the active-state period T_{ACTIVE1} constant. The control circuit may then increase the load current I_{LOAD} of the active-state period T_{ACTIVE1} of the burst-mode period T_{BURST} 1216 by a current offset I_{OS-2} while holding the active-state period T_{ACTIVE1} constant. The current offset I_{OS-2} may be greater than the current offset I_{OS-1}. The current offset I_{OS-2} may be equal to, greater than, or less than twice the current offset I_{OS-1}. For example, the current offset I_{OS-2} may be equal to twice the current offset I_{OS-1} if the intensity of the light source is being increased at a constant rate. The control circuit may increase the average magnitude I_{AVE} of the load current I_{LOAD} during the burst-mode periods T_{BURST} 1212, 1214, 1216 while holding the active-state period T_{ACTIVE1} constant.

The control circuit may adjust the active-state period T_{ACTIVE} and the load current I_{LOAD} of a subsequent burst-mode period T_{BURST}. For example, the control circuit may increase the active-state period T_{ACTIVE2} of the burst-mode period T_{BURST} 1218 and decrease the load current I_{LOAD} of the active-state period T_{ACTIVE2} of the burst-mode period T_{BURST} 1218. The control circuit may increase the active-state period T_{ACTIVE2} of the burst-mode period T_{BURST} 1218 by one inverter cycle, and may set the load current I_{LOAD} of the active-state period T_{ACTIVE2} of the burst-mode period T_{BURST} 1218 to the minimum-rated current I_{MIN}. Although the load current I_{LOAD} of the active-state period T_{ACTIVE2} of the burst-mode period T_{BURST} 1218 is decreased, the average magnitude I_{AVE} of the load current I_{LOAD} is increased due to the increase in the active-state period T_{ACTIVE2}. As such, the control circuit may control (e.g., increase or decrease) the average magnitude I_{AVE} of the load current I_{LOAD} with finer granularity by adjusting both the load current I_{LOAD} and the active-state period T_{ACTIVE} during burst mode.

When increasing the active-state period T_{ACTIVE}, the average magnitude I_{AVE} of the load current I_{LOAD} may be increased due to the application of the load current I_{LOAD} for a greater duration of the burst-mode period T_{BURST}. For example, this may be illustrated by 1250 in FIG. 12B. When increasing the load current I_{LOAD} during burst-mode periods T_{BURST} having the same active-state period T_{ACTIVE}, the load current I_{LOAD} may be increased in excess of the minimum load current I_{MIN} by the current offset I_{OS} (e.g., which may vary between the minimum current offset I_{OS-MIN} and the maximum current offset I_{OS-MAX}). As such, the average magnitude I_{AVE} of the load current I_{LOAD} may be increased due to the application of the current offset I_{OS} in excess of the minimum load current I_{MIN} for the active-state period T_{ACTIVE}, for example, as illustrated by 1230 and 1240 in FIG. 12B.

When determining the value of the current offset I_{OS} for a particular burst-mode period T_{BURST}, the control circuit may ensure that the change (e.g., increase or decrease) in the average magnitude I_{AVE} of the load current I_{LOAD} due to the application of the current offset I_{OS} does not exceed the change (e.g., increase or decrease) in the average magnitude I_{AVE} of the load current I_{LOAD} due to the application of the load current I_{LOAD} for a greater duration of time during the burst-mode period T_{BURST} (i.e., an increase in the active-state period T_{ACTIVE}). For example, referring to FIG. 12B, the control circuit may determine the current offset I_{OS-1} such that the change in the average magnitude I_{AVE} of the load current I_{LOAD} 1230 due to the current offset I_{OS-1} is less than the change in the average magnitude I_{AVE} of the load current I_{LOAD} 1240 due to the current offset I_{OS-2}. Similarly, the control circuit may determine the current offset I_{OS-2} such that the change in the average magnitude I_{AVE} of the load current I_{LOAD} 1240 due to the current offset I_{OS-2} is greater than the change in the average magnitude I_{AVE} of the load current I_{LOAD} 1230 due to the current offset I_{OS-1} and is less than the increase in the average magnitude I_{AVE} of the load current I_{LOAD} 1250 due to the application of the load current I_{LOAD} for a greater duration of time during the burst-mode period T_{BURST} (i.e., the difference between the active-state period T_{ACTIVE1} and the active-state period T_{ACTIVE2}). This may allow the control circuit may case the transitions between adjustments of the active-state period T_{ACTIVE} (e.g., from the active state period T_{ACTIVE1} to the active-state period T_{ACTIVE2}) by adjusting the load current I_{LOAD} by a current offset I_{OS}.

FIG. 12C shows example waveforms 1260, 1280 illustrating an example of how a load control circuit (e.g., the control circuit 150 of the LED driver 100 shown in FIG. 1 and/or the control circuit 150 controlling the forward converter 240 and the current sense circuit 260 shown in FIG. 5) may determine the current offset I_{OS} when holding the active-state period T_{ACTIVE} constant during burst mode, for example, as the target intensity L_{TRGT} of a light source (e.g., the LED light source 202) is increased from the low-end intensity L_{LE}. As noted herein, the burst duty cycle DC_{BURST} (i.e., DC_{BURST-INTEGER}) and in turn the active-state period T_{ACTIVE} may be characterized by one or more inverter cycles.

Referring to example waveform 1260, the active-state period T_{ACTIVE1} of the burst-mode period T_{BURST} 1262 may be characterized by two inverter cycles 1266. In a subsequent burst-mode period T_{BURST} 1264, the control circuit may determine to adjust the average magnitude I_{AVE} of the load current I_{LOAD}, for example, in accordance with the target intensity I_{TRGT}. For example, the control circuit may determine to increase the active-state period T_{ACTIVE3} of the burst mode-period T_{BURST} 1264 by less than one inverter cycle to achieve the increase in the average magnitude I_{AVE} of the load current I_{LOAD}. As such, the active-state period T_{ACTIVE3} of the burst mode-period T_{BURST} 1264 may be characterized by two inverter cycles 1266 and a fractional portion 1268 of a third inverter cycle 1266 where, for example, the increase in the average magnitude I_{AVE} of the load current I_{LOAD} during the burst-mode period T_{BURST} 1264 may be due to the fractional portion 1268 of the third inverter cycle 1266.

As described herein, the ideal burst duty cycle DC_{BURST-IDEAL} of a burst-mode period T_{BURST} may be characterized by an integer portion DC_{BURST-INTEGER} and/or a fractional portion DC_{BURST-FRACTIONAL}. For example, the ideal burst duty cycle DC_{BURST-IDEAL} may follow the ideal curve shown in FIG. 3 (e.g., the ideal burst duty cycle DC_{BURST-IDEAL} may result in the active-state period T_{ACTIVE3}). The integer portion DC_{BURST-INTEGER} may be characterized by the percentage of the ideal burst duty cycle DC_{BURST-IDEAL} that includes complete inverter cycles. The fractional portion DC_{BURST-FRACTIONAL} may be characterized by the percentage of the ideal burst duty cycle DC_{BURST-IDEAL} that includes a fraction of an inverter cycle. For example, as shown in FIG. 12C, the ideal burst duty cycle DC_{BURST-IDEAL} of the burst-mode period T_{BURST} 1262 may include an integer portion DC_{BURST-INTEGER} 1270 (which may be characterized by two inverter cycles 1266), but not include a fractional portion DC_{BURST-FRACTIONAL}. The ideal burst duty cycle DC_{BURST-IDEAL} of the burst-mode period T_{BURST} 1264 may include an integer portion DC_{BURST-INTEGER} 1270 (which may be characterized by two inverter cycles 1266) and a fractional portion DC_{BURST-FRACTIONAL} 1272 (which may be characterized by the fractional portion 1268 of the third inverter cycle 1266).

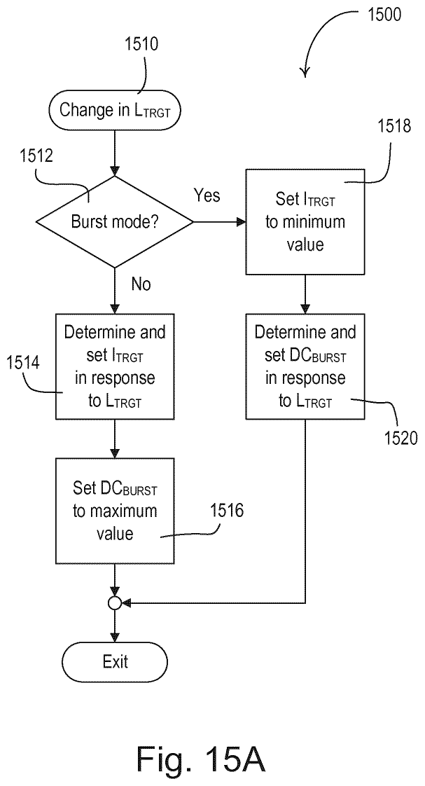

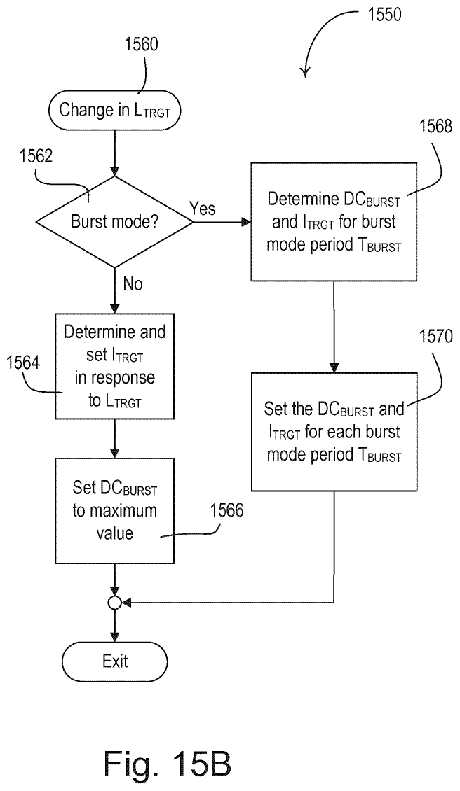

However, the control circuit may be configured to adjust the number of inverter cycles only by an integer number (i.e., by complete inverter cycles) and not by a fractional amount. Therefore, the control circuit may be unable to increase the active-state period T_{ACTIVE3} of the burst-mode period T_{BURST} 1264 by the fractional portion 1268 and in turn increase the burst duty cycle DC_{BURST} of the burst-mode period T_{BURST} 1264 by the fractional portion DC_{BURST-FRACTIONAL} 1272 to increase the average magnitude I_{AVE} of the load current I_{LOAD}. The control circuit may adjust the magnitude of the load current I_{LOAD} by the current offset I_{OS} to compensate for not being able to adjust the number of inverter cycles by a fractional amount, for example, as described with reference to FIG. 15.

As noted above, during burst mode, the control circuit may increase the load current I_{LOAD} of an active-state period T_{ACTIVE} by a current offset I_{OS} in order to increase the average magnitude I_{AVE} of the load current I_{LOAD} to achieve the target intensity L_{TRGT}. The control circuit may determine the current offset I_{OS} based on the fractional portion DC_{BURST-FRACTIONAL} of the ideal burst duty cycle DC_{BURST-IDEAL} for the burst-mode period T_{BURST}, for example, assuming that the control circuit could in fact adjust the number of inverter cycles by a fractional amount. For example, referring to the waveform 1280, the control circuit may determine the current offset I_{OS-1} based on the fractional portion DC_{BURST-FRACTIONAL} 1272 of the ideal burst duty cycle DC_{BURST-IDEAL} of the burst mode period T_{BURST} 1264 from waveform 1260. That is, the control circuit may determine the current offset I_{OS-1} such that an increase 1274 in the load current I_{LOAD} over the active-state period T_{ACTIVE} due to the current offset I_{OS-1} may be equal to (i.e., result in the same adjustment to the average magnitude I_{AVE} of the load current I_{LOAD}) the fractional portion DC_{BURST-FRACTIONAL} 1272. Therefore, the control circuit may adjust the magnitude of the load current I_{LOAD} by the current offset I_{OS} (e.g., current offset I_{OS-1}) to compensate for not being able to adjust the number of inverter cycles by a fractional amount (e.g., the fractional portion DC_{BURST-FRACTIONAL} 1272).

FIG. 13 is an example of a plot relationship between the target load current I_{TRGT} and the burst duty cycle DC_{BURST}, and the target intensity L_{TRGT} of a light source (e.g., the LED light source 202), for example, when a load regulation circuit (e.g., the load regulation circuit 140) is operating in a burst mode and when the load current I_{LOAD} of the light source is near the low-end intensity L_{LE}. Graph 1300 is an example plot of a relationship between the target load current I_{TRGT} and the target intensity L_{TRGT} of the light source. Graph 1310 is an example plot of a relationship between the burst duty cycle DC_{BURST} (i.e., the integer portion of the ideal burst duty cycle DC_{BURST-INTEGER}) and the target intensity L_{TRGT} of the light source. In the graphs 1300 and 1310, the target intensity may range from the transition intensity L_{TRAN} to the low-end intensity L_{LE}.

A control circuit (e.g., the control circuit 150 of the LED driver 100 shown in FIG. 1 and/or the control circuit 150 controlling the forward converter 240 and the current sense circuit 260 shown in FIG. 5) may determine the magnitude of the target load current I_{TRGT} and/or the burst duty cycle DC_{BURST} during burst mode, for example, based on the target intensity L_{TRGT}. The control circuit may determine the target intensity L_{TRGT}, for example, via a digital message received via the communication circuit 180, via a phase-control signal received from a dimmer switch, and/or the like. The target intensity L_{TRGT} may be constant or may be changing (e.g., fading) from one intensity level to another. The control circuit may determine the burst duty cycle DC_{BURST} based on the target intensity L_{TRGT}. After determining the burst duty cycle DC_{BURST}, the control circuit may determine the target load current I_{TRGT} that may be used with the burst duty cycle DC_{BURST} such that the light source is driven to the target intensity L_{TRGT}. The control circuit may determine the burst duty cycle DC_{BURST} and/or the target load current I_{TRGT} by calculating the values in real-time (e.g., as described with reference to FIG. 15) and/or retrieving the values from memory (e.g., via a lookup table or the like).

The control circuit may apply a particular burst duty cycle DC_{BURST} (i.e., DC_{BURST-INTEGER}) for a range of target intensities L_{TRGT}. The control circuit may determine the target load current I_{TRGT} across the range of target intensities L_{TRGT} for the particular burst duty cycle DC_{BURST}, for example, according to a target load current I_{TRGT} profile. The target load current I_{TRGT} profile may vary linearly across the range of target intensities L_{TRGT} for the particular burst duty cycle DC_{BURST}. The target load current I_{TRGT} profile that may be applied across the range of target intensities L_{TRGT} associated with a burst duty cycle DC_{BURST} may be different for different burst duty cycles DC_{BURST}. For example, the target load current I_{TRGT} may be adjusted from the minimum-rated current I_{MIN} to the minimum-rated current I_{MIN} plus the current offset I_{OS}, and the current offset I_{OS} may range from the minimum current offset I_{OS-MIN} to the maximum current offset I_{OS-MAX} based on the burst duty cycle DC_{BURST}. For example, the larger the burst duty cycle DC_{BURST}, then the smaller range of current offsets I_{OS} may be used in the target load current I_{TRGT} profile, and vice versa. This may be done because the minimum rated current I_{MIN} divided by the burst duty cycle DC_{BURST} (i.e., I_{MIN}/DC_{BURST}) may be larger at smaller burst duty cycle DC_{BURST} values. Further, this may be done because the user's sensitively to changes in intensity of the light source may be increased at lower light levels and a more granular adjustment of intensity of the lighting load may be desired at low-end.

Referring to FIG. 13, if the control circuit determines that the target intensity L_{TRGT} falls within the range 1301, then the control circuit may determine to set the burst duty cycle DC_{BURST} (i.e., DC_{BURST-INTEGER}) to DC_{MAX}, and the control circuit may determine to set the target load current I_{LOAD} according to the target load current I_{LOAD} profile 1321. The target load current I_{LOAD} profile 1321 may range from the minimum-rated current I_{MIN} plus the minimum current offset I_{OS-MIN} to the minimum-rated current I_{MIN} based on the target intensity L_{TRGT}. As noted above, the control circuit may determine the burst duty cycle DC_{BURST} and/or the target load current I_{TRGT} by calculating the values in real-time and/or retrieving the values from memory.

If the control circuit determines that the target intensity L_{TRGT} falls within the range 1302, then the control circuit may determine to set the burst duty cycle DC_{BURST} to 1312 (e.g., which may be less than the DC_{MAX}, and the control circuit may determine to set the target load current I_{LOAD} according to the target load current I_{LOAD} profile 1322. Similarly, if the control circuit determines that the target intensity L_{TRGT} falls within one of the target intensity ranges 1303-1307, then the control circuit may determine to set the burst duty cycle DC_{BURST} to one of 1313-1317 and determine to set the target load current I_{LOAD} according to one of the target load current I_{LOAD} profiles 1323-1327, respectively. The maximum target current for consecutive target load current I_{LOAD} profiles may change by a constant amount (e.g., as shown in FIG. 13) or may change by varying amounts (e.g., increase as the target intensity range gets smaller). Further, more or less than seven burst duty cycles DC_{BURST} (i.e., DC_{MAX} through DC_{MIN}) may be provided between the transition intensity L_{TRAN} and the low-end intensity L_{LE}.

When the LED driver is driving a high-power LED light source, the LED light source may conduct larger amounts of current through the LED driver, which may affect the operation of the LED driver when dimming to the low-end intensity L_{LE} (e.g., approximately 1%). For example, the larger current conducted by the high-power LED light source may cause the load current I_{LOAD} to overshoot the minimum rated current I_{MIN} at the beginning of each active state period T_{ACTIVE}.

FIG. 14A shows an example waveform 1400 illustrating an overshoot 1402 in the load current I_{LOAD}, for example, when the LED driver is controlling a high-power LED light source. The overshoot 1402 may be the additional current in excess of the target load current I_{TRGT}. For example, the target load current I_{TRGT} is the minimum rated current I_{MIN} in FIG. 14B. Stated another way, the overshoot 1402 may be characterized by the rise in the magnitude of the load current I_{LOAD} above the target load current I_{TRGT} at the beginning of the active-state period T_{ACTIVE}. Since the LED driver determines the burst duty cycle DC_{BURST} (e.g., and thus the length of the active-state period T_{ACTIVE}) using open-loop control, the overshoot (e.g., the overshoot 1402) may cause the LED driver to deliver more power to the LED light source than intended. In turn, the overshoot 1402 may cause the average load current I_{AVG} to increase in excess of what was intended, and thus the intensity of the LED driver may be greater than intended (e.g., greater than approximately 1%). In addition, the sharp rise in the magnitude of the load current I_{LOAD} at the beginning of the active-state period T_{ACTIVE} (i.e., the overshoot 1402) may cause audible noise (e.g., buzzing) in the magnetic components of the load regulation circuit of the LED driver (e.g., in the transformer 220 and/or the inductor L226 of the load regulation circuit 240 shown in FIG. 5).

Accordingly, the control circuit of the LED driver may be configured to control the rise time of the load current I_{LOAD} at the beginning of each active-state period T_{ACTIVE}. FIG. 14B shows an example waveform 1450 illustrating control of the rise time of the load current I_{LOAD} at the beginning of each active-state period T_{ACTIVE}. The control circuit 150 may detect an overshoot of the load current I_{LOAD}, for example, based on the load current I_{LOAD} as determined by the load regulation circuit, based on the sense voltage V_{SENSE}, based on the load current feedback signal V_{I-LOAD}, and/or the like. The control circuit 150 may determine to control the rise time of the load current I_{LOAD} at the beginning of an active-state period T_{ACTIVE}. For example, the control circuit 150 may determine to control the rise time of the load current I_{LOAD} to prevent the overshoot from continuing to occur. In one or more embodiments, the control circuit 150 may determine to control the rise time of the load current I_{LOAD} at any time during operation and/or for any reason, for example, the control circuit 150 may be preconfigured to control of the rise time of the load current I_{LOAD} at the beginning of each active-state period T_{ACTIVE}. The control circuit 150 may determine the on-times T_{ON} of the drive control signals V_{DRIVE1}, V_{DRIVE2} for controlling the inverter circuit of the forward converter 240 (e.g., using the load current feedback signal V_{I-LOAD}). The control circuit 150 may be configured to increase (e.g., ramp up) the load current I_{LOAD} from an initial current I_{INIT} to the target load current I_{TRGT} (e.g., the minimum rated current I_{MIN} or to the minimum-rated current I_{MIN} plus the current offset I_{OS}) over a ramp time period T_{RAMP}, for example, as shown in FIG. 14B. For example, the ramp time period T_{RAMP} may be approximately 200 microseconds. In addition, the initial current I_{INIT} may be approximately 40% of the minimum-rated current I_{MIN}, but could range from zero amps to slightly less than the minimum-rated current I_{MIN}.

Since the magnitude of the load current I_{LOAD} is less than the minimum-rated current I_{MIN} during the ramp time period T_{RAMP}, the control circuit 150 does not regulate the magnitude of the load current I_{LOAD} in response to the load current feedback signal V_{I-LOAD} during the ramp time period T_{RAMP}. After freezing the control loop during the inactive-state period T_{INACTIVE}, the control circuit 150 may maintain the control loop in the frozen state while the control circuit is adjusting the on-times T_{ON} of the drive control signals V_{DRIVE1}, V_{DRIVE2} to ramp the load current I_{LOAD} up to the target load current I_{TRGT} during the ramp time period T_{RAMP}. After the ramp time period T_{RAMP}, the control circuit waits for a wait time period T_{WAIT} (e.g., approximately 200 microseconds) before beginning to regulate the magnitude of the load current I_{LOAD} during a regulation time period T_{REG}. As such, the control loop may be frozen for the duration of the inactive-state period T_{INACTIVE}, the ramp time period T_{RAMP}, and the wait time period T_{WAIT}, and the control loop may be unfrozen (active) during the regulation time period T_{REG}. Ramping up the load current I_{LOAD} during the active-state period T_{ACTIVE} of the burst mode may prevent the load current I_{LOAD} from overshooting the minimum-rated current I_{MIN} at the beginning of each active-state period T_{ACTIVE}. The wait time period T_{WAIT} may be used to allow for the load current I_{LOAD} to stabilize. In one or more embodiments, the wait time period T_{WAIT} may be omitted.

FIG. 14B may not be to scale. For example, in one or more embodiments, the ramp time period T_{RAMP} may be approximately one-quarter of a pulse width (e.g., approximately 200 microseconds), the wait time period T_{WAIT} may be approximately one-quarter of a pulse width (e.g., approximately 200 microseconds), and the regulation time period T_{REG} may be approximately one-half of a pulse width (e.g., approximately 200 microseconds). The invention is not so limited, and the ramp time period T_{RAMP}, the wait time period T_{WAIT}, and the regulation time period T_{REG} may be in different proportions of the pulse width.

The target intensity L_{TRGT} may be associated with a target amount of power delivered to the electrical load. For example, although the example illustrated in FIGS. 2 and 3 are with relation to target intensity L_{TRGT}, the control circuit (e.g., control circuit 150) may be configured to adjust the target load current I_{TRGT} to control the target amount of power delivered to the electrical load and/or the control circuit may be configured to adjust the burst duty cycle DC_{BURST} in response to the target amount of power when operating in the burst mode. For example, the control circuit may be configured to adjust the burst duty cycle DC_{BURST} linearly with respect to the target amount of power when operating in the burst mode. Further, the control circuit may be configured to operate in the burst mode when the target amount of power is less than a transition amount of power. The transition amount of power may be power delivered to the electrical load when the electrical load is controlled to be the transition intensity L_{TRAN}.

FIGS. 15A, 15B, 16, 17A, 17B and 18 are simplified flowcharts of example procedures for operating a forward converter in a normal mode and a burst mode. The procedures of FIGS. 15A, 15B, 16, 17A, 17B, and 18 may be executed by a control circuit of a load control device (e.g., the control circuit 150 of the LED driver 100 shown in FIG. 1 and/or the control circuit 150 controlling the forward converter 240 and the current sense circuit 260 shown in FIG. 5).

FIG. 15A is a simplified flowchart of an example target intensity procedure 1500 that may be executed when the target intensity L_{TRGT} is adjusted at 1510 (e.g., in response to digital messages received via the communication circuit 180). The control circuit may determine if it is operating the forward converter in the burst mode at 1512 (e.g., the target intensity L_{TRGT} is between the high-end intensity L_{HE} and the transition intensity L_{TRAN}, i.e., L_{TRAN}≤L_{TRGT}≤L_{HE}). If the control circuit determines it is not operating the forward converter in the burst mode (e.g., but rather in the normal mode) at 1512, then the control circuit may determine and set the target load current I_{TRGT} as a function of the target intensity L_{TRGT} at 1514 (e.g., as shown in FIG. 2). The control circuit may then set the burst duty cycle DC_{BURST} equal to a maximum duty cycle DC_{MAX} (e.g., approximately 100%) at 1516 (e.g., as shown in FIG. 3), and the control circuit may exit the target intensity procedure 1500.

If the control circuit determines that it is operating the forward converter in the burst mode at 1512 (e.g., the target intensity L_{TRGT} is below the transition intensity L_{TRAN}, i.e., L_{TRGT}<L_{TRAN}), then the control circuit may set the target load current I_{TRGT} to a minimum value (e.g., to the minimum rated current I_{MIN}) at 1518 (e.g., as shown in FIG. 2). The control circuit may then determine and set the burst duty cycle DC_{BURST} as a function of the target intensity L_{TRGT} at 1520 (e.g., using open-loop control as shown in FIG. 3), and the control circuit may exit the target intensity procedure 1500.

FIG. 15B is a simplified flowchart of an example target intensity procedure 1550 that may be executed when the target intensity L_{TRGT} is adjusted at 1560 (e.g., in response to digital messages received via the communication circuit 180). The control circuit may determine if it is operating the forward converter in the burst mode at 1562 (e.g., the target intensity L_{TRGT} is between the high-end intensity L_{HE} and the transition intensity L_{TRAN}, i.e., L_{TRAN}≤L_{TRGT}≤L_{HE}). If the control circuit determines that it is not operating the forward converter in the burst mode (e.g., but rather in the normal mode), then the control circuit may determine and set the target load current I_{TRGT} as a function of the target intensity L_{TRGT} at 1564 (e.g., as shown in FIG. 2). The control circuit may then set the burst duty cycle DC_{BURST} equal to a maximum duty cycle DC_{MAX} (e.g., approximately 100%) at 1566 (e.g., as shown in FIG. 3), and the control circuit may exit the target intensity procedure 1550.

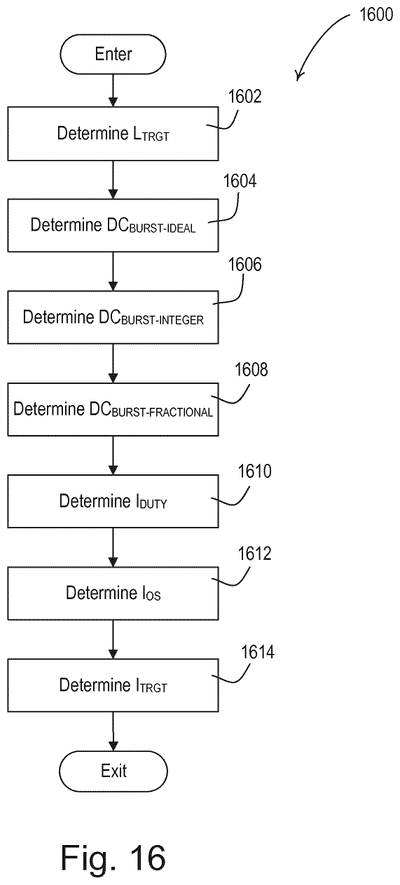

If the control circuit determines that it is operating the forward converter in the burst mode at 1562 (e.g., the target intensity L_{TRGT} is below the transition intensity L_{TRAN}, i.e., L_{TRGT}<L_{TRAN}), then the control circuit may determine the burst duty cycle DC_{BURST} and target load current I_{TRGT} for one or more burst mode periods T_{BURST} (e.g., using open loop control) at 1568. For example, the control circuit may determine the burst duty cycle DC_{BURST} and/or the target load current I_{TRGT} by calculating the values in real-time (e.g., as described with reference to FIG. 16) and/or retrieving the values from memory (e.g., via a lookup table or the like). The control circuit may determine the burst duty cycle DC_{BURST} and target load current I_{TRGT} for a plurality of burst mode periods T_{BURST} that may be used when adjusting the intensity of the light load to the target intensity L_{TRGT}, for example, as described with reference to FIG. 12B and/or FIG. 13. The control circuit may then set the burst duty cycle DC_{BURST} and target load current I_{TRGT} for each of the plurality of burst mode periods T_{BURST} at 1570, for example, until the intensity of the lighting load equals the target intensity L_{TRGT}, and the control circuit may exit the target intensity procedure 1550.

FIG. 16 is a simplified flowchart of an example target load current I_{TRGT} procedure 1600. The target load current I_{TRGT} procedure 1600 may be executed periodically (e.g., every 66 microseconds). In one or more embodiments, the target load current I_{TRGT} procedure 1600 may be executed during 1568 of the target intensity procedure 1550. The control circuit may determine the burst duty cycle DC_{BURST} (e.g., ideal burst duty cycle DC_{BURST-IDEAL}, integer portion of the ideal burst duty cycle DC_{BURST-INTEGER}, and/or fractional portion of the ideal burst duty cycle DC_{BURST-FRACTIONAL}), the current offset I_{OS}, and target load current I_{TRGT} for controlling the lighting load at the beginning of every burst mode period T_{BURST}, for example, using the target load current I_{TRGT} procedure 1600. The target load current I_{TRGT} procedure 1600 may begin at 1602 where the control circuit may determine the target intensity L_{TRGT}. The control circuit may determine the target intensity L_{TRGT}, for example, via a digital message received via the communication circuit 180, via a phase-control signal received from a dimmer switch, and/or the like. The target intensity L_{TRGT} may be constant or may be changing from one intensity level to another.

After determining the target intensity L_{TRGT}, the control circuit may determine the ideal burst duty cycle DC_{BURST-IDEAL} at 1604. The ideal burst duty cycle DC_{BURST-IDEAL} may be adjusted linearly as the target intensity L_{TRGT} is adjusted between the low-end intensity L_{LE} and the transition intensity L_{TRAN}. For example, the control circuit may determine the ideal burst duty cycle DC_{BURST-IDEAL} based on the target intensity L_{TRGT} using the graph of FIG. 3. The ideal burst duty cycle DC_{BURST-IDEAL} may include an integer portion DC_{BURST-INTEGER} and/or a fractional portion DC_{BURST-FRACTIONAL}, for example, as described with reference to FIG. 12C.

The control circuit may determine the integer portion of the ideal burst duty cycle DC_{BURST-INTEGER} at 1606. For example, the control circuit may determine the integer portion of the burst duty cycle DC_{BURST-INTEGER} by rounding the ideal duty cycle DC_{BURST-IDEAL} down to the next closest integer value using the following equation:

$$D {C}_{B URST - INTEGER} = Round - Down ( D {C}_{B U RST - IDEAL} ) , \qquad ( Eq . 4 )$$

The control circuit may determine the fractional portion of the ideal burst duty cycle DC_{BURST-FRACTIONAL} at 1608. For example, the control circuit may determine the fractional portion of the ideal burst duty cycle DC_{BURST-FRACTIONAL} by subtracting the integer portion of the burst duty cycle DC_{BURST-INTEGER} from the ideal burst duty cycle DC_{BURST-IDEAL}, for example, using the following equation:

$$D {C}_{BURST - FRACTIONAL} = D {C}_{B U RST - IDEAL} - D {C}_{B U RST - INTEGER} . \qquad ( Eq . 5 )$$

As noted herein, the fractional portion of the ideal burst duty cycle DC_{BURST-FRACTIONAL} may be characterized by the percentage of the ideal burst duty cycle DC_{BURST-IDEAL} that includes a fraction of an inverter cycle. And since the control circuit may be configured to adjust the number of inverter cycles only by an integer number and not a fractional amount (i.e., by DC_{BURST-FRACTIONAL}), the control circuit may determine the current offset I_{OS} for the burst mode period T_{BURST} such that an increase in the load current I_{LOAD} due to the current offset I_{OS} may be equal to (i.e., result in the same adjustment to the average magnitude I_{AVE} of the load current I_{LOAD}) the fractional portion DC_{BURST-FRACTIONAL}.

The control circuit may determine the average current I_{DUTY} generated during a burst mode period T_{BURST} having a burst duty cycle DC_{BURST-CYCLE} that comprises one inverter cycle using the minimum rated current I_{MIN} at 1610. The minimum rated current I_{MIN} may be the peak current when the target intensity L_{TRGT} is less than the transition intensity L_{TRAN}, for example, as shown in FIG. 2. For example, the control circuit may determine the average current I_{DUTY} that is generated during a burst mode period T_{BURST} having a burst duty cycle DC_{BURST-CYCLE} that comprises one inverter cycle, for example according to the following equation:

$${I}_{DUTY} = {I}_{MIN} / D {C}_{B U R S T} \qquad ( Eq . 6 )$$

The control circuit may determine the current offset I_{OS} according to the amount of current I_{DUTY} generated during a burst duty cycle DC_{BURST-CYCLE} that comprises one inverter cycle and the fractional portion of the ideal burst duty cycle DC_{BURST-FRACTIONAL} at 1612. For example, the control circuit may multiply the fractional portion of the ideal burst duty cycle DC_{BURST-FRACTIONAL} by the average current I_{DUTY} generated during a burst mode period T_{BURST} having a burst duty cycle DC_{BURST-CYCLE} that comprises one inverter cycle to determine the current offset I_{OS}, for example, according to the following equation:

$${I}_{O S} = {I}_{DUTY} \cdot D {C}_{B U RST - FRACTIONAL} . \qquad ( Eq . 7 )$$

After determining the current offset I_{OS}, the control circuit may add the current offset I_{OS} to the minimum rated current I_{MIN} to determine the target current I_{TRGT} for the target intensity L_{TRGT} at 1614, and the control circuit may exit the target load current I_{TRGT} procedure 1600. Since the control circuit may be configured to adjust the number of inverter cycles by an integer number and not a fractional amount, the control circuit may operate in burst mode by using the integer portion of the burst duty cycle DC_{BURST-INTEGER}, and by using the current offset I_{OS} in lieu of the fractional portion of the ideal burst duty cycle DC_{BURST-FRACTIONAL}. As such, the control circuit may control the load current I_{LOAD} to achieve the target intensity although it may not be able to operate at the ideal burst duty cycle DC_{BURST-IDEAL}.

In one or more embodiments, the control circuit may determine a scaled target intensity L_{SCALED} and use the scaled target intensity L_{SCALED} in lieu of the target intensity L_{TRGT} when determining the ideal burst duty cycle DC_{BURST-IDEAL} during the target load current I_{TRGT} procedure 1600. For example, the may determine and use the scaled target intensity L_{SCALED} when the low-end intensity L_{LE} and/or the minimum burst duty cycle DC_{MIN} are not zero (e.g., when the low-end intensity L_{LE} is approximately in the range of 0.1%-1%). The scaled target intensity L_{SCALED} may be based on the target intensity L_{TRGT}, the minimum burst duty cycle DC_{MIN}, and the maximum burst duty cycle DC_{MAX}. For example, the control circuit may determine the scaled target intensity L_{SCALED} using the following equation:

$${L}_{SCALED} = \frac{( {L}_{T R G T} - {L}_{L E} ) \cdot [ ( {L}_{T R A N} \cdot D {C}_{MAX} ) - ( {L}_{T R A N} \cdot D {C}_{MIN} ) ]}{( {L}_{T R A N} - {L}_{L E} )} + ( {L}_{TRAN} \cdot D {C}_{MIN} ) . \qquad ( Eq . 8 )$$

After determining the scaled target intensity L_{SCALED}, the control circuit may determine the ideal burst duty cycle DC_{BURST-IDEAL} based on the scaled target intensity L_{SCALED}, for example, at 1604, and the target load current I_{TRGT} procedure 1600 may proceed as described herein. For example, the control circuit may determine the ideal burst duty cycle DC_{BURST-IDEAL} based on the scaled target intensity L_{SCALED} using the following equation:

$$D {C}_{BURST} = ( {L}_{SCALED} / {L}_{TRAN} ) \cdot {T}_{BURST} \qquad ( Eq . 9 )$$

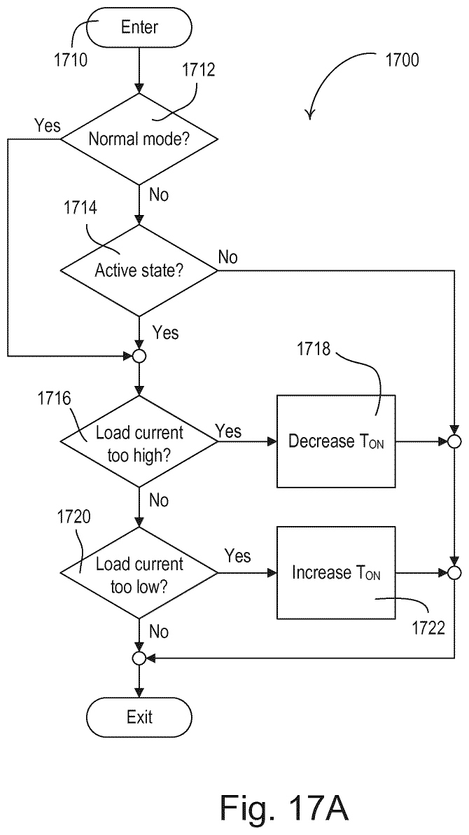

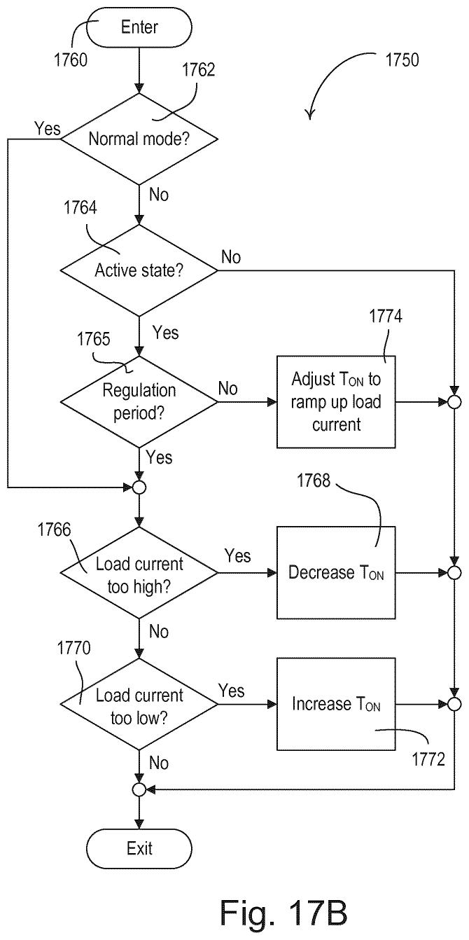

FIG. 17A is a simplified flowchart of an example control loop procedure 1700, which for example, may be executed periodically (e.g., every 66 microseconds). The control loop procedure 1700 may begin at 1710. For example, the control circuit may execute the control loop procedure 1700 to adjust the on-time T_{ON} of the drive control signals V_{DRIVE1}, V_{DRIVE2} (e.g., and thus the duty cycle DC_{INV} of the inverter voltage V_{INV}) in response to the magnitude of the load current I_{LOAD} determined from the load current feedback signal V_{I-LOAD} received from the current sense circuit. The control circuit may determine if it is operating the forward converter in the normal mode at 1712. If not, then the control circuit may determine if it is operating the forward converter in the active state of burst mode at 1714. If the control circuit is operating the forward converter in the normal mode or in the active state of burst mode, then the control circuit may adjust the on-time T_{ON} of the drive control signals V_{DRIVE1}, V_{DRIVE2} in response to the load current feedback signal V_{I-LOAD}. For example, the control circuit may determine if the magnitude of the load current I_{LOAD} is too high at 1716 (e.g., I_{LOAD}>I_{TRGT}). If the magnitude of the load current I_{LOAD} is too high, the control circuit may decrease the on-time T_{ON} of the drive control signals V_{DRIVE1}, V_{DRIVE2} at 1718. For example, at 1718, the control circuit may decrease the on-time T_{ON} by a predetermined amount or by an amount dependent upon the magnitude of the error between the target load current I_{TRGT} and the magnitude of the load current I_{LOAD}. After decreasing the on-time T_{ON} of the drive control signals V_{DRIVE1}, V_{DRIVE2}, the control circuit may exit the control loop procedure 1700.

If the control circuit determines that the magnitude of the load current I_{LOAD} is not too high at 1716, then the control circuit may determine whether the magnitude of the load current I_{LOAD} is too low at 1720 (e.g., I_{LOAD}<I_{TRGT}). If the control circuit may determines that the magnitude of the load current I_{LOAD} is too low, the control circuit may increase the on time T_{ON} of the drive control signals V_{DRIVE1}, V_{DRIVE2} at 1722. For example, at 1722, the control circuit may increase the on-time T_{ON} by a predetermined amount or by an amount dependent upon the magnitude of the error between the target load current I_{TRGT} and the magnitude of the load current I_{LOAD}. After increasing the on-time T_{ON} of the drive control signals V_{DRIVE1}, V_{DRIVE2}, the control circuit may exit the control loop procedure 1700. If the control circuit determines that the magnitude of the load current I_{LOAD} is not too high at 1716 and is not too low at 1720, the control circuit may exit the control loop procedure 1700.

If the control circuit is operating the forward converter in the inactive state of the burst mode, the control circuit may exit the control loop procedure 1700 without adjusting the on-time T_{ON} of the drive control signals V_{DRIVE1}, V_{DRIVE2}. Accordingly, the control circuit may freeze the control loop when in the inactive state of the burst mode by not adjusting the on-time T_{ON} of the drive control signals V_{DRIVE1}, V_{DRIVE2} in response to the average magnitude I_{AVE} of the load current I_{LOAD}. If the magnitude of the load current I_{LOAD} is approximately zero amps during the inactive state, the control circuit may maintain the on-time T_{ON} of the drive control signals V_{DRIVE1}, V_{DRIVE2} (e.g., as stored in the memory 170) to be equal to the last value of the on time from the previous active state. The control circuit may control the magnitude of the load current to the minimum rated current I_{MIN} during the next active state.

FIG. 17B is a simplified flowchart of an example control loop procedure 1750, which for example, may be executed periodically (e.g., every 66 microseconds). For example, the control loop procedure 1750 may be executed by the control circuit to avoid overshoot in the load current I_{LOAD} at the beginning of each active state period T_{ACTIVE} by ramping up the load current I_{LOAD} (e.g., as shown in FIG. 14B). The control loop procedure 1750 may begin at 1760. The control circuit may determine if it is operating the forward converter in the normal mode at 1762. If not, then the control circuit may determine if it is operating the forward converter in the active state of burst mode at 1764. If the control circuit is operating the forward converter in the active state of the burst mode at 1764, the control circuit may then determine at 1765 if it should be presently regulating the load current (e.g., if it is operating in the regulation time period T_{REG} as shown in FIG. 14B).

If the control circuit is operating the forward converter in the normal mode or in the regulation time period T_{REG} of the active state of burst mode, then the control circuit may adjust the on-time T_{ON} of the drive control signals V_{DRIVE1}, V_{DRIVE2} in response to the load current feedback signal V_{I-LOAD}. For example, the control circuit may determine if the magnitude of the load current I_{LOAD} is too high at 1766 (e.g., I_{LOAD}>I_{TRGT}). If the magnitude of the load current I_{LOAD} is too high, the control circuit may decrease the on-time T_{ON} of the drive control signals V_{DRIVE1}, V_{DRIVE2} at 1768. For example, at 1768, the control circuit may decrease the on-time T_{ON} by a predetermined amount or by an amount dependent upon the magnitude of the error between the target load current I_{TRGT} and the magnitude of the load current I_{LOAD}. After decreasing the on-time T_{ON} of the drive control signals V_{DRIVE1}, V_{DRIVE2}, the control circuit may exit the control loop procedure 1750.

If the control circuit determines that the magnitude of the load current I_{LOAD} is not too high at 1766, then the control circuit may determine whether the magnitude of the load current I_{LOAD} is too low at 1770 (e.g., I_{LOAD}<I_{TRGT}). If the control circuit determines that the magnitude of the load current I_{LOAD} is too low, the control circuit may increase the on-time T_{ON} of the drive control signals V_{DRIVE1}, V_{DRIVE2} at 1772. For example, at 1772, the control circuit may increase the on-time T_{ON} by a predetermined amount or by an amount dependent upon the magnitude of the error between the target load current I_{TRGT} and the magnitude of the load current I_{LOAD}. After increasing the on-time T_{ON} of the drive control signals V_{DRIVE1}, V_{DRIVE2}, the control circuit may exit the control loop procedure 1750. If the control circuit determines that the magnitude of the load current I_{LOAD} is not too high at 1766 and is not too low at 1770, the control circuit may exit the control loop procedure 1750.

If the control circuit is operating the forward converter in the inactive state of the burst mode at 1764, the control circuit may exit the control loop procedure 1750 without adjusting the on-time T_{ON} of the drive control signals V_{DRIVE1}, V_{DRIVE2}. Accordingly, the control circuit may freeze the control loop when in the inactive state of the burst mode by not adjusting the on-time TON of the drive control signals V_{DRIVE1}, V_{DRIVE2} in response to the average magnitude I_{AVE} of the load current I_{LOAD}. If the magnitude of the load current I_{LOAD} is approximately zero amps during the inactive state, the control circuit may maintain the on-time T_{ON} of the drive control signals V_{DRIVE1}, V_{DRIVE2} (e.g., as stored in the memory 170) to be equal to the last value of the on time from the previous active state.

If the control circuit is operating the forward converter in the active state of the burst mode at 1764, but is not in the regulation time period T_{REG} at 1765, the control circuit may adjust the on time T_{ON} of the drive control signals V_{DRIVE1}, V_{DRIVE2} using open loop control at 1774 to ramp up the load current at the beginning of each active state time period T_{ACTIVE} (e.g., during the ramp time period T_{RAMP} as shown in FIG. 14B). The control circuit may also wait for the wait time period T_{WAIT} before once again beginning to adjust the on-time T_{ON} of the drive control signals V_{DRIVE1}, V_{DRIVE2} in response to the average magnitude I_{AVE} of the load current I_{LOAD} during the next regulation time period T_{REG}. Accordingly, the control circuit may maintain the control loop frozen when not in the regulation time period T_{REG} in the active state of the burst mode. The control circuit may control the magnitude of the load current to the minimum-rated current I_{MIN} during the next regulation time period T_{REG}.

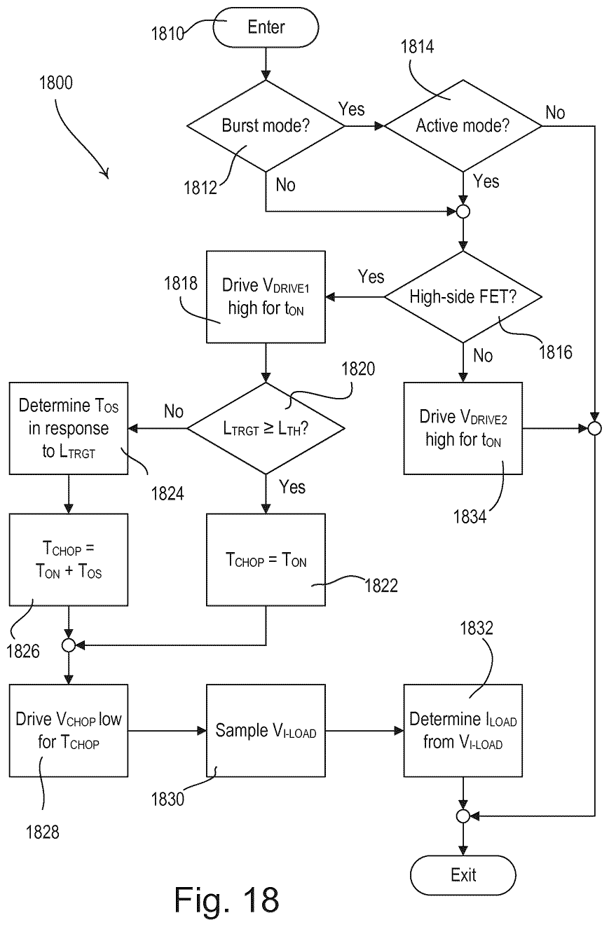

FIG. 18 is a simplified flowchart of an example drive signal procedure 1800, for example, which may be executed periodically. The drive signal procedure 1800 may begin at 1810. The drive signal procedure 1800 may be executed periodically in accordance with the operating period T_{OP} of the inverter voltage V_{INV} of the forward converter 240. For example, the control circuit may execute the drive signal procedure 1800 to generate the drive control signals V_{DRIVE1}, V_{DRIVE2} using the on-time T_{ON} determined during the control loop procedure 1700 of FIG. 17A or the control loop procedure 1750 of FIG. 17B. The control circuit may determine whether it is operating the forward converter in the normal mode at 1812. If not, then the control circuit may determine whether it is operating the forward converter in the active state of the burst mode at 1814. If the control circuit is operating the forward converter in the normal mode or in the active state of the burst mode, the control circuit may determine whether the high-side FET Q210 or the low-side FET Q212 should be controlled at 1816. If the control circuit determines that it should control the high-side FET Q210 at 1816, the control circuit may drive the first drive control signal V_{DRIVE1} high to approximately the supply voltage V_{CC} for the on-time T_{ON} at 1818.

The control circuit may determine the magnitude of the load current I_{LOAD} from the load current feedback signal V_{I-LOAD}. The control circuit may determine if the target intensity L_{TRGT} is greater than or equal to the threshold intensity L_{TH} at 1820. If so, the control circuit may set the signal-chopper time T_{CHOP} equal to the on-time T_{ON} at 1822. If the control circuit determines that the target intensity L_{TRGT} is less than the threshold intensity L_{TH} at 1820, the control circuit may determine the offset-time T_{OS} in response to the target intensity L_{TRGT} at 1824 (e.g., using one or more of the relationships shown in FIGS. 9 and 10). The control signal may set the signal-chopper time T_{CHOP} equal to the sum of the on-time T_{ON} and the offset-time T_{OS} at 1826.

Next, the control circuit may drive the signal-chopper control signal V_{CHOP} low towards circuit common for the signal-chopper time T_{CHOP} at 1828. The control circuit may sample the averaged load current feedback signal V_{I-LOAD} at 1830. The control circuit may calculate the magnitude of the load current I_{LOAD} using the sampled value at 1832. For example, the control circuit may calculate the magnitude of the load current I_{LOAD} at 1832 using the following equation:

$${I}_{L O A D} = \frac{{n}_{T U R N S} \cdot {V}_{I - LOAD} \cdot {T}_{H C}}{{R}_{S E N S E} \cdot ( {T}_{C H O P} - {T}_{D E L A Y} )} , \qquad ( Eq . 10 )$$

where T_{DELAY} is the total delay time due to the turn-on time and the turn-off time of the FETs Q210, Q212 (e.g., T_{DELAY}=T_{TURN-ON}−T_{TURN-OFF}), which may be equal to approximately 200 microseconds. Finally, the control circuit may exit the drive signal procedure 1800 after determining the magnitude of the load current I_{LOAD}.

If the control circuit determines that it should control the low-side FET Q212 at 1816, the control circuit may drive the second drive control signal V_{DRIVE2} high to approximately the supply voltage V_{CC} for the on-time TON at 1834. The control circuit may exit the drive signal procedure 1800 without the control circuit driving the signal-chopper control signal V_{CHOP} low or determining the magnitude of the load current I_{LOAD} from the load current feedback signal V_{I-LOAD}. If the control circuit determines that it is operating the forward converter in the burst mode at 1812 and in the inactive state at 1814, the control circuit may exit the drive signal procedure 1800 without generating the drive control signals V_{DRIVE1}, V_{DRIVE2}.

One or more of the embodiments described herein (e.g., as performed by a load control device) may be used to decrease the intensity of a lighting load and/or increase the intensity of the lighting load. For example, one or more embodiments described herein may be used to adjust the intensity of the lighting load from on to off, off to on, from a higher intensity to a lower intensity, and/or from a lower intensity to a higher intensity. For example, one or more of the embodiments described herein (e.g., as performed by a load control device) may be used to fade the intensity of a light source from on to off (i.e., the low-end intensity L_{LE} may be equal to 0%) and/or to fade the intensity of the light source from off to on.

Although described with reference to an LED driver, one or more embodiments described herein may be used with other load control devices. For example, one or more of the embodiments described herein may be performed by a variety of load control devices that are configured to control of a variety of electrical load types, such as, for example, a LED driver for driving an LED light source (e.g., an LED light engine); a screw-in luminaire including a dimmer circuit and an incandescent or halogen lamp; a screw-in luminaire including a ballast and a compact fluorescent lamp; a screw-in luminaire including an LED driver and an LED light source; a dimming circuit for controlling the intensity of an incandescent lamp, a halogen lamp, an electronic low-voltage lighting load, a magnetic low-voltage lighting load, or another type of lighting load; an electronic switch, controllable circuit breaker, or other switching device for turning electrical loads or appliances on and off; a plug-in load control device, controllable electrical receptacle, or controllable power strip for controlling one or more plug-in electrical loads (e.g., coffee pots, space heaters, other home appliances, and the like); a motor control unit for controlling a motor load (e.g., a ceiling fan or an exhaust fan); a drive unit for controlling a motorized window treatment or a projection screen; motorized interior or exterior shutters; a thermostat for a heating and/or cooling system; a temperature control device for controlling a heating, ventilation, and air conditioning (HVAC) system; an air conditioner; a compressor; an electric baseboard heater controller; a controllable damper; a humidity control unit; a dehumidifier; a water heater; a pool pump; a refrigerator; a freezer; a television or computer monitor; a power supply; an audio system or amplifier; a generator; an electric charger, such as an electric vehicle charger; and an alternative energy controller (e.g., a solar, wind, or thermal energy controller). A single control circuit may be coupled to and/or adapted to control multiple types of electrical loads in a load control system.

What is claimed is:

1. A light-emitting diode (LED) lighting controller, comprising:
load regulation circuitry couplable to an LED lighting load;
control circuitry to generate one or more drive signal to cause the load regulation circuitry to control an average load current delivered to the operatively coupled LED lighting load, the control circuitry to:
receive an input that includes a target intensity for an operatively coupled LED lighting load;
determine one or more parameters associated with the received target intensity;
cause the load regulation circuitry to operate in the first mode responsive to a determination that the one or more parameters associated with the target intensity fall within a defined parameter range;
wherein, in the first mode, the load regulation circuitry continuously supplies a load current to the LED lighting load; and
cause the load regulation circuitry to operate in the second mode responsive to the determination that the one or more parameters associated with the target intensity fall below the defined parameter range;
wherein, in the second mode, the load regulation circuitry periodically supplies the load current to the LED lighting load.

2. The LED lighting controller of claim 1 wherein to cause the load regulation circuitry to operate in the first mode responsive to the determination that the one or more parameters associated with the target intensity fall within the defined parameter range, the LED lighting control circuitry to further:
cause the load regulation circuitry to operate at a fixed duty cycle and vary a load current delivered to the LED lighting load.

3. The LED lighting controller of claim 1 wherein to cause the load regulation circuitry to operate in the second mode responsive to the determination that the one or more parameters associated with the target intensity fall below the defined parameter range, the LED lighting control circuitry to further:
cause the load regulation circuitry to operate on an adjustable duty cycle that alternates between an active state and an inactive state to provide an average load current to the LED lighting load.

4. The LED lighting controller of claim 3 wherein to cause the load regulation circuitry to operate on the adjustable duty cycle that alternates between the active state and the inactive state to provide the average load current to the LED lighting load, the LED lighting control circuitry to further:
cause the load regulation circuitry to maintain a minimum duty cycle by varying a period of the duty cycle to adjust the average load current to the LED lighting load.

5. The LED lighting controller of claim 3, wherein to cause the load regulation circuitry to operate on the adjustable duty cycle that alternates between the active state and the inactive state, the LED lighting control circuitry to further:
cause the load regulation circuitry to provide the minimum fixed load current to the LED lighting load during the active state; and
cause the load regulation circuitry to not provide load current to the LED lighting load during the inactive state.

6. The LED lighting controller of claim 1:
wherein to determine the one or more parameters associated with the received target intensity, the LED lighting control circuitry to further:
determine a target load current to provide to the LED lighting load based on the received target intensity; and
wherein to cause the load regulation circuitry to operate in the first mode responsive to the determination that the one or more parameters associated with the target intensity fall within the defined parameter range, the LED lighting control circuitry to further:
cause the load regulation circuitry to operate in the first mode responsive to the determination that the determined target load current falls within a defined target load current range.

7. The LED lighting controller of claim 6 wherein to cause the load regulation circuitry to operate in the second mode responsive to the determination that the one or more parameters associated with the target intensity fall below the defined parameter range, the LED lighting control circuitry to further:
cause the load regulation circuitry to operate in the second mode responsive to the determination that the determined target load current falls below the defined target load current range.

8. The LED lighting controller of claim 1:
wherein to determine the one or more parameters associated with the received target intensity, the LED lighting control circuitry to further:
determine a target load power to provide to the LED lighting load based on the received target intensity; and
wherein to cause the load regulation circuitry to operate in the first mode responsive to the determination that the one or more parameters associated with the target intensity fall within the defined parameter range, the LED lighting control circuitry to further:
cause the load regulation circuitry to operate in the first mode responsive to the determination that the determined target load power falls within a defined target load current range.

9. The LED lighting controller of claim 8 wherein to cause the load regulation circuitry to operate in the second mode responsive to the determination that the one or more parameters associated with the target intensity fall below the defined parameter range, the LED lighting control circuitry to further:
cause the load regulation circuitry to operate in the second mode responsive to the determination that the determined target load power falls below the defined target load power range.

10. A light-emitting diode (LED) lighting control method comprising:
receiving, by LED lighting control circuitry, an input that includes a target intensity for an operatively coupled LED lighting load;
determining, by the LED lighting control circuitry, one or more parameters associated with the received target intensity;
causing, by the LED lighting control circuitry, the load regulation circuitry to operate in the first mode responsive to a determination that the one or more parameters associated with the target intensity fall within a defined parameter range;
wherein, in the first mode, the load regulation circuitry continuously supplies a load current to the LED lighting load; and
causing, by the LED lighting control circuitry, the load regulation circuitry to operate in the second mode responsive to the determination that the one or more parameters associated with the target intensity fall below the defined parameter range;
wherein, in the second mode, the load regulation circuitry periodically supplies the load current to the LED lighting load.

11. The LED lighting control method of claim 10 wherein causing the load regulation circuitry to operate in the first mode responsive to the determination that the one or more parameters associated with the target intensity fall within the defined parameter range further comprises:
causing, by the LED lighting control circuitry, the load regulation circuitry to operate at a fixed duty cycle and vary a load current delivered to the LED lighting load.

12. The LED lighting control method of claim 10 wherein causing the load regulation circuitry to operate in the second mode responsive to the determination that the one or more parameters associated with the target intensity fall below the defined parameter range further comprises:
causing, by the LED lighting control circuitry, the load regulation circuitry to operate on an adjustable duty cycle that alternates between an active state and an inactive state to provide an average load current to the LED lighting load.

13. The LED lighting control method of claim 12, wherein causing the load regulation circuitry to operate on the adjustable duty cycle that alternates between the active state and the inactive state to provide the average load current to the LED lighting load further comprises:
causing, by the LED lighting control circuitry, the load regulation circuitry to maintain a minimum duty cycle by varying a period of the duty cycle to adjust the average load current to the LED lighting load.

14. The LED lighting control method of claim 12, wherein causing the load regulation circuitry to operate on the adjustable duty cycle that alternates between the active state and the inactive state further comprises;
causing, by the LED lighting control circuitry, the load regulation circuitry to provide the minimum fixed load current to the LED lighting load during the active state; and
causing, by the LED lighting control circuitry, the load regulation circuitry to not provide load current to the LED lighting load during the inactive state.

15. The LED lighting control method of claim 10:
wherein determining one or more parameters associated with the received target intensity further comprises:
determining, by the LED lighting control circuitry, a target load current to provide to the LED lighting load based on the received target intensity; and
wherein causing the load regulation circuitry to operate in the first mode responsive to the determination that the one or more parameters associated with the target intensity fall within the defined parameter range further comprises:
causing, by the LED lighting control circuitry, the load regulation circuitry to operate in the first mode responsive to the determination that the determined target load current falls within a defined target load current range.

16. The LED lighting control method of claim 15 wherein causing the load regulation circuitry to operate in the second mode responsive to the determination that the one or more parameters associated with the target intensity fall below the defined parameter range further comprises:
causing, by the LED lighting control circuitry, the load regulation circuitry to operate in the second mode responsive to the determination that the determined target load current falls below the defined target load current range.

17. The LED lighting control method of claim 10:
wherein determining one or more parameters associated with the received target intensity further comprises:
determining, by the LED lighting control circuitry, a target load power to provide to the LED lighting load based on the received target intensity; and
wherein causing the load regulation circuitry to operate in the first mode responsive to the determination that the one or more parameters associated with the target intensity fall within the defined parameter range further comprises:
causing, by the LED lighting control circuitry, the load regulation circuitry to operate in the first mode responsive to the determination that the determined target load power falls within a defined target load current range.

18. The LED lighting control method of claim 17 wherein causing the load regulation circuitry to operate in the second mode responsive to the determination that the one or more parameters associated with the target intensity fall below the defined parameter range further comprises:
causing, by the LED lighting control circuitry, the load regulation circuitry to operate in the second mode responsive to the determination that the determined target load power falls below the defined target load power range.

19. A non-transitory, machine-readable, storage device that includes instructions that, when executed by light-emitting diode (LED) lighting control circuitry, cause the LED lighting control circuitry to:
receive an input that includes a target intensity for an operatively coupled LED lighting load;
determine one or more parameters associated with the received target intensity;
cause operatively coupled load regulation circuitry to operate in the first mode responsive to a determination that the one or more parameters associated with the target intensity fall within a defined parameter range;
wherein, in the first mode, the load regulation circuitry continuously supplies a load current to the LED lighting load; and
cause the load regulation circuitry to operate in the second mode responsive to the determination that the one or more parameters associated with the target intensity fall below the defined parameter range;
wherein, in the second mode, the load regulation circuitry periodically supplies the load current to the LED lighting load.

20. The non-transitory, machine-readable, storage device of claim 19 wherein the instructions that cause the LED lighting control circuitry to cause the load regulation circuitry to operate in the first mode responsive to the determination that the one or more parameters associated with the target intensity fall within the defined parameter range, further cause the LED lighting control circuitry to:
cause the load regulation circuitry to operate at a fixed duty cycle and vary a load current delivered to the LED lighting load.

21. The non-transitory, machine-readable, storage device of claim 19 wherein the instructions that cause the LED lighting control circuitry to cause the load regulation circuitry to operate in the second mode responsive to the determination that the one or more parameters associated with the target intensity fall below the defined parameter range, further cause the LED lighting control circuitry to:
cause the load regulation circuitry to operate on an adjustable duty cycle that alternates between an active state and an inactive state to provide an average load current to the LED lighting load.

22. The non-transitory, machine-readable, storage device of claim 21 wherein the instructions that cause the LED lighting control circuitry to cause the load regulation circuitry to operate on the adjustable duty cycle that alternates between the active state and the inactive state to provide the average load current to the LED lighting load, further cause the LED lighting control circuitry to:
cause the load regulation circuitry to maintain a minimum duty cycle by varying the period of the duty cycle to adjust the average load current to the LED lighting load.

23. The non-transitory, machine-readable, storage device of claim 21 wherein the instructions that cause the LED lighting control circuitry to cause the load regulation circuitry to operate on the adjustable duty cycle that alternates between the active state and the inactive state, further cause the LED lighting control circuitry to:
cause the load regulation circuitry to provide the minimum fixed load current to the LED lighting load during the active state; and
cause the load regulation circuitry to not provide load current to the LED lighting load during the inactive state.

24. The non-transitory, machine-readable, storage device of claim 19:
wherein the instructions that cause the LED lighting control circuitry to determine the one or more parameters associated with the received target intensity, further cause the LED lighting control circuitry to:
determine a target load current to provide to the LED lighting load based on the received target intensity; and
wherein the instructions that cause the LED lighting control circuitry to cause the load regulation circuitry to operate in the first mode responsive to the determination that the one or more parameters associated with the target intensity fall within the defined parameter range, further cause the LED lighting control circuitry to:
cause the load regulation circuitry to operate in the first mode responsive to the determination that the determined target load current falls within a defined target load current range.

25. The non-transitory, machine-readable, storage device of claim 24 wherein the instructions that cause the LED lighting control circuitry to cause the load regulation circuitry to operate in the second mode responsive to the determination that the one or more parameters associated with the target intensity fall below the defined parameter range, further cause the LED lighting control circuitry to:
cause the load regulation circuitry to operate in the second mode responsive to the determination that the determined target load current falls below the defined target load current range.

26. The non-transitory, machine-readable, storage device of claim 19:
wherein the instructions that cause the LED lighting control circuitry to determine the one or more parameters associated with the received target intensity, further cause the LED lighting control circuitry to:
determine a target load power to provide to the LED lighting load based on the received target intensity; and
wherein the instructions that cause the LED lighting control circuitry to cause the load regulation circuitry to operate in the first mode responsive to the determination that the one or more parameters associated with the target intensity fall within the defined parameter range, further cause the LED lighting control circuitry to:
cause the load regulation circuitry to operate in the first mode responsive to the determination that the determined target load power falls within a defined target load current range.

27. The non-transitory, machine-readable, storage device of claim 26 wherein the instructions that cause the LED lighting control circuitry to cause the load regulation circuitry to operate in the second mode responsive to the determination that the one or more parameters associated with the target intensity fall below the defined parameter range, further cause the LED lighting control circuitry to:
cause the load regulation circuitry to operate in the second mode responsive to the determination that the determined target load power falls below the defined target load power range.
